(19) United States
(12) Patent Application Publication
(10) Pub. No.: US 2026/0112301 A1
(43) Pub. Date: Apr. 23, 2026

(54) DISPLAY DEVICE AND ELECTRONIC DEVICE

(71) Applicant: Samsung Display Co., LTD., Yongin-si (KR)

(72) Inventors: JAEHYUN KOH, Yongin-si (KR); DOWON KIM, Yongin-si (KR); MIN-WEUN KIM, Yongin-si (KR); WOONYONG LIM, Yongin-si (KR)

(21) Appl. No.: 19/300,031

(22) Filed: Aug. 14, 2025

(30) Foreign Application Priority Data
Oct. 18, 2024 (KR) 10-2024-0142607

(51) Int. Cl. G09G 3/20

(52) U.S. Cl. CPC G09G 3/2092; G09G 3/2007; G09G 2300/0819; G09G 2300/0842; G09G 2300/0861; G09G 2320/0626; G09G 2320/0673; G09G 2330/021; G09G 2330/028

(57) ABSTRACT

A display device includes a display panel, a gate driver, a data driver which applies a data voltage based on a data signal and a gamma reference voltage to the pixel, a gamma reference voltage generator which applies the gamma reference voltage to the data voltage, a voltage generator which outputs power voltages, and a driving controller. The pixel may emit light according to a grayscale setting which is based on the power voltages and the data voltage. The voltage generator may change at least one power voltage of the power voltages based on a luminance settingluminance setting. The gamma reference voltage generator may change the gamma reference voltage based on the luminance settingluminance setting. The driving controller may generate the data signal based on a change in the at least one power voltage and a change in the gamma reference voltage.

This application claims priority to Korean Patent Application No. 10-2024-0142607, filed on Oct. 18, 2024, and all the benefits accruing therefrom under 35 U.S.C. § 119, the content of which in its entirety is herein incorporated by reference.

### BACKGROUND

### 1. Field

Embodiments supported by aspects of the present disclosure relate to a display device and an electronic device. More particularly, embodiments of the present disclosure relate to a display device and an electronic device for improving display quality.

### 2. Description of the Related Art

Generally, a display device includes a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines and a driving controller controlling the gate driver, the data driver and the emission driver.

Generally, a power voltage of a display device may be changed for reducing power consumption of the display device.

### SUMMARY

Embodiments supported by aspects of the present disclosure provide a display device for improving display quality by compensating for an influence according to change in a power consumption.

Embodiments supported by aspects of the present disclosure provide an electronic device for improving display quality by compensating for an influence according to change in a power consumption.

According to embodiments, a display device may include a display panel including a pixel, a gate driver which outputs a gate signal to the pixel, a data driver which applies a data voltage to the pixel based on a data signal and a gamma reference voltage, a gamma reference voltage generator which applies the gamma reference voltage to the data voltage, a voltage generator which outputs power voltages to the display panel and a driving controller which generates the data signal and controls the gate driver, the data driver, the voltage generator, and the gamma reference voltage generator. The pixel may emit light according to a grayscale setting which is based on the power voltages and the data voltage. The voltage generator may change at least one power voltage of the power voltages based on a luminance settingluminance setting. The gamma reference voltage generator may change the gamma reference voltage based on the luminance settingluminance setting. The driving controller may generate the data signal based on a change in the at least one power voltage and a change in the gamma reference voltage.

In an embodiment, the power voltage may include a high power voltage and a low power voltage lower than the high power voltage. When the luminance settingluminance setting is changed to a second luminance settingluminance setting higher than a first luminance settingluminance setting, the voltage generator may reduce the low power voltage.

In an embodiment, the gamma reference voltage may include a gamma high voltage and a gamma low voltage. When the luminance setting is changed to the second luminance setting, the gamma reference voltage generator may reduce the gamma low voltage.

In an embodiment, grayscale data voltages corresponding to a grayscale according to which the pixel emits light may be stored in a grayscale voltage lookup table. Power voltage offset voltages corresponding to the change in the at least one power voltage may be stored in a power voltage offset lookup table. The driving controller may generate the data signal based on the grayscale voltage lookup table and the power voltage offset lookup table.

In an embodiment, the data signal may be outputted based on a grayscale data voltage of the grayscale data voltages and a power voltage offset voltage of the power voltage offset voltages.

In an embodiment, the data signal may be outputted based on a voltage which is a sum of the grayscale data voltage and the power voltage offset voltage.

In an embodiment, gamma voltage offset voltages corresponding to the change in the gamma reference voltage may be stored in a gamma voltage offset lookup table.

In an embodiment, the data signal may be outputted based on a grayscale data voltage of the grayscale data voltages, a power voltage offset voltage of the power voltage offset voltages, and a gamma voltage offset voltage of the gamma voltage offset voltages.

In an embodiment, the data signal may be outputted based on a voltage which is a sum of the grayscale data voltage, the power voltage offset voltage, and the gamma voltage offset voltage.

In an embodiment, the gamma voltage offset lookup table may include a first gamma voltage offset lookup table corresponding to the first luminance setting and a second gamma voltage offset lookup table corresponding to a third luminance setting higher than the first luminance setting. In the second luminance setting, a gamma voltage offset voltage of the gamma voltage offset voltages may be determined by using linear interpolation on the first gamma voltage offset lookup table and the second gamma voltage offset lookup table.

In an embodiment, the power voltage offset lookup table may include a first power voltage offset lookup table corresponding to the first luminance setting and a second power voltage offset lookup table corresponding to a third luminance setting higher than the first luminance setting. In the second luminance setting, a power voltage offset voltage may be determined by using linear interpolation on the first power voltage offset lookup table and the second power voltage offset lookup table.

In an embodiment, the at least one power voltage may include a high power voltage and a low power voltage lower than the high power voltage. When the luminance setting is changed to a second luminance setting higher than a first luminance setting, the voltage generator may increase the high power voltage.

In an embodiment, the gamma reference voltage may include a gamma high voltage and a gamma low voltage. When the luminance setting is changed to the second luminance setting, the gamma reference voltage generator may increase the gamma high voltage.

In an embodiment, grayscale data voltages corresponding to a grayscale according to which the pixel emits light may be stored in a grayscale voltage lookup table. Power voltage offset voltages corresponding to the change in the at least one power voltage may be stored in a power voltage offset lookup table. The driving controller may generate the data signal based on the grayscale voltage lookup table and the power voltage offset lookup table.

In an embodiment, the data signal may be outputted based on a grayscale data voltage of the grayscale data voltages and a power voltage offset voltage of the power voltage offset voltages.

In an embodiment, gamma voltage offset voltages corresponding to the change in the gamma reference voltage may be stored in a gamma voltage offset lookup table. The data signal may be generated based on the grayscale voltage lookup table, the power voltage offset lookup table, and the gamma voltage offset lookup table.

In an embodiment, the data signal may be outputted based on a grayscale data voltage of the grayscale data voltages, a power voltage offset voltage of the power voltage offset voltages, and a gamma voltage offset voltage of the gamma voltage offset voltages.

According to embodiments, an electronic device may include a display panel including a pixel, a gate driver which outputs a gate signal to the pixel, a data driver which applies a data voltage to the pixel based on a data signal and a gamma reference voltage, a gamma reference voltage generator which applies the gamma reference voltage to the data voltage, a voltage generator which outputs power voltages to the display panel, a driving controller which generates the data signal and controls the gate driver, the data driver, the voltage generator, and the gamma reference voltage generator and a processor which outputs input image data and an input control signal. The pixel may emit light according to a grayscale setting which is based on the power voltages and the data voltage. The voltage generator may change at least one power voltage of the power voltages based on a luminance setting. The gamma reference voltage generator may change the gamma reference voltage based on the luminance setting. The driving controller may generate the data signal based on a change in the at least one power voltage and a change in the gamma reference voltage.

In an embodiment, the power voltage may include a high power voltage and a low power voltage lower than the high power voltage. When the luminance setting is changed to a second luminance setting higher than a first luminance setting, the voltage generator may reduce the low power voltage.

In an embodiment, the gamma reference voltage may include a gamma high voltage and a gamma low voltage. When the luminance setting is changed to the second luminance setting, the gamma reference voltage generator may reduce the gamma low voltage.

As described herein, the driving voltages may be changed based on the luminance setting. Accordingly, a power consumption of the display device may be reduced based on the luminance setting.

Some of the plurality of offset lookup tables may be generated by performing linear interpolation on the remainder of the plurality of offset lookup tables. Accordingly, some of the offset lookup tables may be generated without using a determining apparatus. Accordingly, the efficiency of a manufacturing process may be improved.

In some aspects, the low power voltage may be changed according to a change in the luminance setting. For generating a data signal according to a change in the low power voltage, the plurality of low power voltage offset lookup tables may be generated. The data signal may be generated based on the low power offset lookup table corresponding to the changed low power voltage. Accordingly, the data signal considering panel characteristics may be generated. In some aspects, an influence due to a change in the low power voltage according to the luminance setting may be considered. Accordingly, color distortion and/or brightness stability of the display panel may be improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the present disclosure.

FIG. 2 is a block diagram illustrating an example of a driving controller included in a display device of FIG. 1.

FIG. 3 is a block diagram illustrating an example of a power generator included in a display device of FIG. 1.

FIG. 4 is a graph illustrating an example of a low power voltage outputted from a power voltage outputter included in a voltage generator of FIG. 3.

FIG. 5 is a block diagram illustrating an example of a gamma reference voltage generator included in a display device of FIG. 1.

FIG. 6 is a graph illustrating an example of a gamma bottom voltage outputted from a gamma reference voltage outputter included in a gamma reference voltage generator of FIG. 5.

FIG. 7 is diagram illustrating an example of a plurality of power voltage offset lookup tables stored in a driving controller of FIG. 2.

FIG. 8 is a table illustrating an example of a power voltage offset lookup table of FIG. 7.

FIG. 9 is diagram illustrating an example of a plurality of gamma reference voltage offset lookup tables stored in a driving controller of FIG. 2.

FIG. 10 is a table illustrating an example of a gamma reference voltage offset lookup table of FIG. 7.

FIG. 11 is a circuit diagram illustrating an example of a pixel included a display device of FIG. 1.

FIG. 12 is a circuit diagram illustrating an example of a pixel included a display device of FIG. 1.

FIG. 13 is a graph illustrating an example of a high power voltage outputted from a power voltage outputter included in a voltage generator of FIG. 3, and applied to a pixel of FIG. 12.

FIG. 14 is diagram illustrating an example of a plurality of power voltage offset lookup tables stored in a driving controller of FIG. 2.

FIG. 15 is a table illustrating an example of a power voltage offset lookup table of FIG. 14.

FIG. 16 is a block diagram illustrating an example of a gamma reference voltage generator included in a display device of FIG. 1.

FIG. 17 is a block diagram illustrating an example of a driving controller included in a display device of FIG. 1.

FIG. 18 is a block diagram illustrating an electronic device according to embodiments of the present disclosure.

FIG. 19 is a diagram illustrating an example in which the electronic device of FIG. 18 is implemented as a smart phone.

### DETAILED DESCRIPTION

Embodiments supported by the present disclosure will now be described more fully hereinafter with reference to the accompanying drawings, in which one or more example embodiments are illustrated. Aspects supported by the present disclosure may, however, be embodied in different forms and should not be construed as limited to the embodiments set forth herein. Rather, these example embodiments are provided so that this disclosure will be thorough and complete, and will fully convey the scope of example aspects of the invention to those skilled in the art.

Terms such as, for example, first, second, and the like may be used to describe various components, but the components should not be limited by the terms. The terms as used herein may distinguish one component from other components and are not to be limited by the terms. For example, without departing the scope of the present disclosure, a first component may be referred to as a second component, and similarly, the second component may also be referred to as the first component. The terms of a singular form may include plural forms unless otherwise specified.

The terminology used herein is for the purpose of describing particular embodiments and is not intended to be limiting. As used herein, “a,” “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, comp The terms “about” or “approximately” as used herein are inclusive of the stated value and include a suitable range of deviation for the particular value as determined by one of ordinary skill in the art, considering the measurement in question and the error associated with measurement of the particular quantity. The term “about” can mean within one or more standard deviations, or within ±30%, 20%, 10%, 5% of the stated value, for example.

The term “substantially,” as used herein, means approximately or actually. The term “substantially equal” means approximately or actually equal. The term “substantially the same” means approximately or actually the same. The term “substantially identical” means approximately or actually identical. The term “substantially perpendicular” means approximately or actually perpendicular.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Embodiments are described herein with reference to cross section illustrations that are schematic illustrations of example embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases.

It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

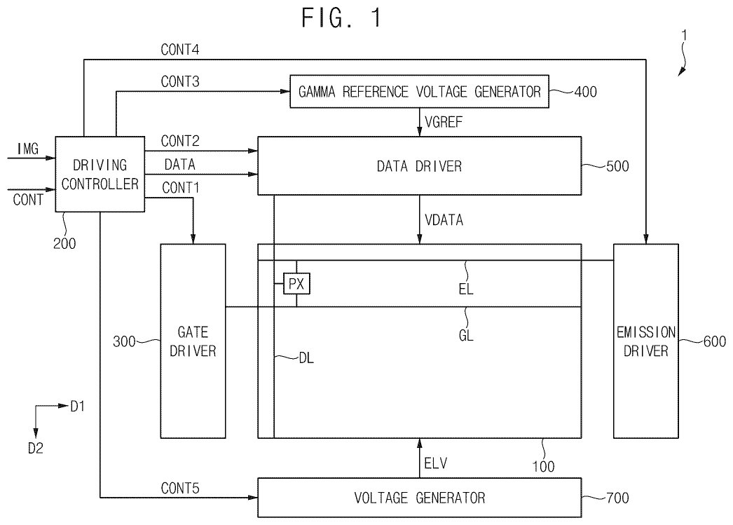

FIG. 1 is a block diagram illustrating a display device 1 according to embodiments of the present disclosure.

Referring to FIG. 1, the display device 1 may include a display panel 100 and a display panel driver. The display panel driver may include a driving controller 200, a gate driver 300, a gamma reference voltage generator 400, a data driver 500 and an emission driver 600. In an embodiment, the display panel driver may further include a voltage generator 700.

The display panel 100 may have a display region on which an image is displayed and a peripheral region adjacent to the display region.

The display panel 100 may include a plurality of gate lines GL, plurality of emission lines EL, a plurality of data lines DL and a plurality of pixel circuits PX electrically connected to the gate lines GL, the emission lines EL and the data lines DL. The gate lines GL may extend in a first direction D1, the emission lines EL may extend in the first direction D1 and the data lines DL may extend in a second direction D2 crossing the first direction D1.

The display panel 100 may emit light based on a luminance setting. For example, the luminance setting may be a luminance set by user. For example, the luminance setting may be a maximum luminance according to which the display panel 100 may emit light. For example, the luminance setting may be a maximum luminance at which the display panel 100 displays light according to a grayscale corresponding to white. For example, the grayscale corresponding to white may be a grayscale level of about 255. However, embodiments of the present disclosure are not limited to a value of the grayscale level corresponding to white. For example, the luminance setting may be about 3000 nit. For example, the luminance setting may be about 600 nit. However, embodiments of the present disclosure are not limited to a value of the luminance setting.

The pixel may emit light based on the data voltage VDATA and a power voltage ELV.

The driving controller 200 may receive input image data IMG and an input control signal CONT from an external apparatus. For example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, a fifth control signal CONT5 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the gate driver 300.

The driving controller 200 may generate the fifth control signal CONT5 for controlling an operation of the voltage generator 700 based on the input control signal CONT, and output the fifth control signal CONT5 to the voltage generator 700.

The gate driver 300 may generate gate signals driving the gate lines GL in response to the first control signal CONT1 received from the driving controller 200. In an embodiment, the gate driver 300 may receive a gate high voltage and a gate low voltage from the voltage generator 700. The gate driver 300 may output the gate signals to the gate lines GL. For example, the gate signals may include a write gate signal, a compensation gate signal, an initialization gate signal, a reset gate signal and a light emitting element initialization gate signal. The gate signals may toggle between the gate high voltage and the gate low voltage.

In an embodiment, the gate driver 300 may be disposed in the peripheral region. In an embodiment, the gate driver 300 may be integrated in the peripheral region.

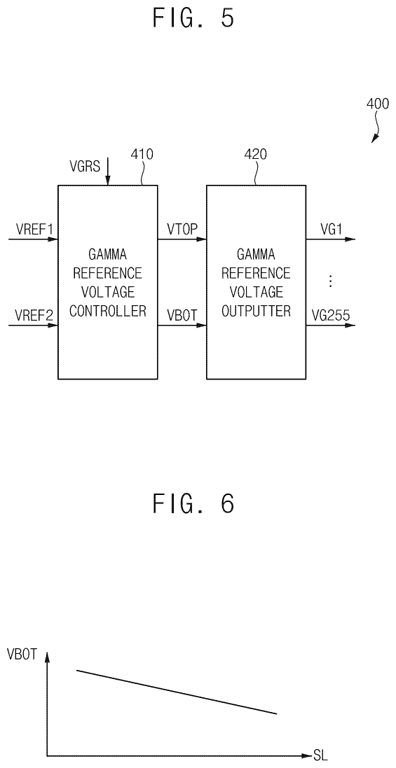

The gamma reference voltage generator 400 may generate a gamma reference voltage VGREF in response to the third control signal CONT3 received from the driving controller 200. The gamma reference voltage VGREF may be generated based on a gamma top voltage VTOP of FIG. 5 and a gamma bottom voltage VBOT of FIG. 5. For example, a range of the gamma reference voltage VGREF may be substantially the same as a range between the gamma top voltage VTOP of FIG. 5 and the gamma bottom voltage VBOT of FIG. 5. For example, a maximum value of the gamma reference voltage VGREF may be the gamma top voltage VTOP of FIG. 5. For example, a minimum value of the gamma reference voltage VGREF may be the gamma bottom voltage VBOT of FIG. 5. The gamma reference voltage generator 400 may provide the gamma reference voltage VGREF to the data driver 500. The gamma reference voltage VGREF may have a value corresponding to a level of the data signal DATA.

In the present embodiment, the gamma reference voltage generator 400 may change the gamma reference voltage VGREF. For example, the gamma reference voltage generator 400 may change the gamma reference voltage VGREF based on the luminance setting of the display panel 100. In an example in which the luminance setting is changed from a first luminance setting to a second luminance setting higher than the first luminance setting, the gamma reference voltage generator 400 may increase the range of the gamma reference voltage VGREF.

In an embodiment, the gamma reference voltage generator 400 may change the gamma bottom voltage VBOT of FIG. 5. For example, the gamma reference voltage generator 400 may change the gamma bottom voltage VBOT of FIG. 5 based on the luminance setting of the display panel 100. In an example in which the luminance setting is changed from a first luminance setting to a second luminance setting higher than the first luminance setting, the gamma reference voltage generator 400 may decrease a voltage level of the gamma bottom voltage VBOT of FIG. 5.

In an embodiment, the gamma reference voltage generator 400 may change the gamma top voltage VTOP of FIG. 5. For example, the gamma reference voltage generator 400 may change the gamma top voltage VTOP of FIG. 5 based on the luminance setting of the display panel 100. In an example in which the luminance setting is changed from a first luminance setting to a second luminance setting higher than the first luminance setting, the gamma reference voltage generator 400 may increase a voltage level of the gamma top voltage VTOP of FIG. 5.

In an embodiment, the gamma reference voltage generator 400 may be disposed in the driving controller 200, or in the data driver 500.

The data driver 500 may receive the second control signal CONT2 and the data signal DATA from the driving controller 200, and receive the gamma reference voltages VGREF from the gamma reference voltage generator 400. The data driver 500 may convert the data signal DATA into data voltages VDATA of an analog type using the gamma reference voltages VGREF. The data driver 500 may output the data voltages VDATA to the data lines DL. The data voltages VDATA may be voltages based on which the pixel PX emits light according to a grayscale setting. Based on a voltage level (also referred to herein as a data voltage level) of the data voltage VDATA, the pixel PX may emit light according to a grayscale value (or gradation value) corresponding to the voltage level.

In an embodiment, the data driver 500 may be disposed in the peripheral region of the display panel 100. In an embodiment, the data driver 500 may be integrated in the peripheral region of the display panel 100.

The emission driver 600 may generate emission signal in response to the fourth control signal CONT4 received from the driving controller 200. The emission driver 600 may output the emission signal to the display panel 100.

In an embodiment, the emission driver 600 may be disposed in the peripheral region. In an embodiment, the emission driver 600 may be integrated in the peripheral region.

Although the gate driver 300 is disposed on a first side of the display panel 100, and the emission driver 600 is disposed on a second side of the display panel 100 in FIG. 1 for convenience of explanation, embodiments of the present disclosure are not limited thereto. The gate driver 300 and the emission driver 600 may be disposed on the first side of the display panel 100. For example, the gate driver 300 and the emission driver 600 may be disposed on the peripheral region of the display panel 100 on the same side of the display region of the display panel 100. For example, the gate driver 300 and the emission driver 600 may be formed integrally with each other.

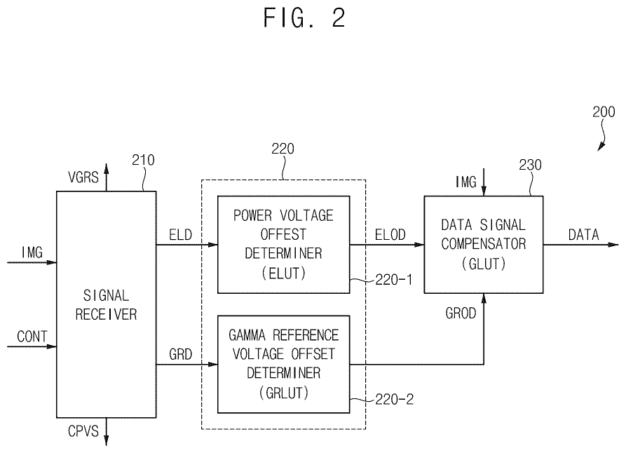

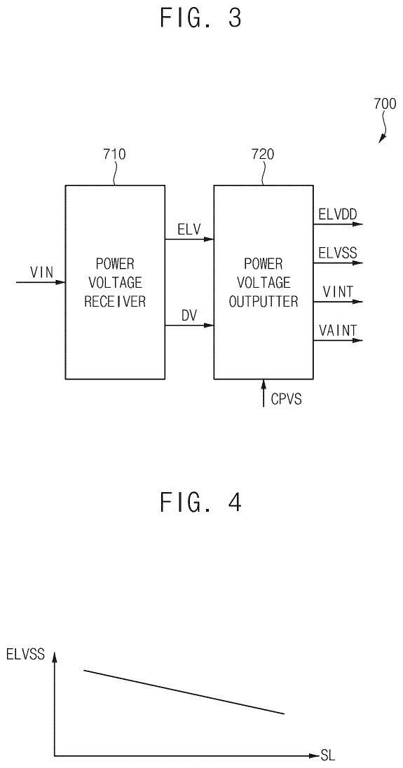

The voltage generator 700 may generate a power voltage ELV in response to the fifth control signal CONT5 received from the driving controller 200. The power voltage ELV may include the high power voltage ELVDD of FIG. 3, the low power voltage ELVSS of FIG. 3, the initialization voltage VINT of FIG. 3 and the light emitting element initialization voltage VAINT of FIG. 3. However, embodiments of the present disclosure are not limited to a voltage included in the power voltage ELV. The fifth control signal CONT5 may include a voltage generation control signal CDVS of FIG. 2.

In the present embodiment, the voltage generator 700 may change the power voltage ELV. The voltage generator 700 may change the power voltage ELV based on the luminance setting of the display panel 100. In an example in which the luminance setting is changed from a first luminance setting to a second luminance setting higher than the first luminance setting, the voltage generator 700 may increase a voltage level of at least one power voltage of the power voltages.

For example, the at least one power voltage may be the low power voltage ELVSS of FIG. 3. In an example in which the luminance setting is changed from a first luminance setting to a second luminance setting higher than the first luminance setting, the voltage generator 700 may increase an absolute value of the low power voltage ELVSS of FIG. 3. In an example in which the luminance setting is changed from a first luminance setting to a second luminance setting higher than the first luminance setting, the voltage generator 700 may change the low power voltage ELVSS of FIG. 3 from about −4V to about −5V. However, embodiments of the present disclosure are not limited to a value of the low power voltage ELVSS of FIG. 3.

For example, the at least one power voltage may be the initialization voltage VINT of FIG. 3. In an example in which the luminance setting is changed from a first luminance setting to a second luminance setting higher than the first luminance setting, the voltage generator 700 may increase an absolute value of the initialization voltage VINT of FIG. 3.

For example, the at least one power voltage may be the light emitting element initialization voltage VAINT of FIG. 3. In an example in which the luminance setting is changed from a first luminance setting to a second luminance setting higher than the first luminance setting, the voltage generator 700 may increase an absolute value of the light emitting element initialization voltage VAINT of FIG. 3.

In the present embodiment, the power voltage ELV may be changed based on the luminance setting, such that a power consumption of the display device 1 may be reduced.

FIG. 2 is a block diagram illustrating an example of a driving controller 200 included in a display device 1 of FIG. 1.

Referring to FIG. 1 and FIG. 2, the driving controller 200 may include a signal receiver 210, an offset determiner 220 and a data signal compensator 230. The offset determiner 220 may include a power voltage offset determiner 220-1 and a gamma reference voltage offset determiner 220-2.

The signal receiver 210 may receive the input image data IMG and the input control signal CONT. The signal receiver 210 may output power a power voltage generating control signal CPVS and power voltage changed data ELD referring to a change in the power voltage ELV based on the input control signal CONT. The signal receiver 210 may output power a gamma reference voltage generating control signal VGRS and gamma reference voltage changed data GRD referring to a change in the gamma reference voltage VGREF based on the

### Input Control Signal Cont.

The change in the power voltage ELVD may mean a difference of the power voltage ELV changed based on a change in the luminance setting. For example, the change in the power voltage ELVD may mean that a voltage level difference between a first power voltage in a first luminance setting and a second power voltage in a second luminance setting. In an example in which a first low power voltage in the first luminance setting is about −4V, and a second low power voltage in the second luminance setting is about −5V, the change in the power voltage ELVD may be about 1V. The power voltage changed data ELD may mean data about a power voltage difference based on a change in the luminance setting.

The change in the gamma reference voltage VGREF may mean a difference of the gamma reference voltage VGREF changed based on a change in the luminance setting.

In an embodiment, the gamma bottom voltage VBOT of FIG. 5 may be changed based on the change in the luminance setting. In an example in which the gamma bottom voltage VBOT of FIG. 5 is changed based on the change in the luminance setting, the change in the gamma reference voltage VGREF may mean a voltage level difference between a first gamma bottom voltage in a first luminance setting and a second gamma bottom voltage in a second luminance setting. In an example in which the first gamma bottom voltage in the first luminance setting is about 3V, and the second gamma bottom voltage in the second luminance setting is about 2V, the change in the gamma reference voltage VGREF may be about 1V. The gamma reference voltage changed data GRD may mean data about a gamma reference voltage difference based on a change in the luminance setting.

In an embodiment, the gamma top voltage VTOP of FIG. 5 may be changed based on the change in the luminance setting. In an example in which the gamma top voltage VTOP of FIG. 5 is changed based on the change in the luminance setting, the change in the gamma reference voltage VGREF may mean a voltage level difference between a first top bottom voltage in a first luminance setting and a second gamma top voltage in a second luminance setting. In an example in which the first gamma top voltage in the first luminance setting is about 7V, and the second gamma top voltage in the second luminance setting is about 9V, the change in the gamma reference voltage VGREF may be about 2V. The gamma reference voltage changed data GRD may mean data about a gamma reference voltage difference based on a change in the luminance setting.

The power voltage offset determiner 220-1 may output power voltage offset data ELOD based on the power voltage changed data ELD. The power voltage offset data ELOD may be generated based on a power voltage offset lookup table ELUT corresponding to a change in the power voltage ELV. The power voltage offset lookup table ELUT may be stored in a manufacturing process of the display device 1. The power voltage offset lookup table ELUT may include offset voltages considering a panel characteristic (e.g., a size of the display panel, a material of the display panel, etc.). For example, the data voltage VDATA such that the pixel PX emits at a luminance setting may be changed based on the panel characteristic. The power voltage offset voltage may be considered to the data voltage VDATA, such that the pixel PX may emit at the luminance setting.

The power voltage offset lookup table ELUT may include the offset voltages corresponding to grayscales in which the pixel PX can emit. For example, the power voltage offset lookup table ELUT may include a first power voltage offset voltage corresponding to a first grayscale, a second power voltage offset voltage corresponding to a second grayscale to a P-th power voltage offset voltage corresponding to a P-th grayscale. Herein, P is a positive integer. For example, the P-th grayscale may be about 255 grayscale level. However, embodiments of the present disclosure are not limited to a value of a maximum grayscale in which the pixel emits. For example, in the manufacturing process of the display device 1, by using a determining apparatus, the power voltage offset voltage in which the panel characteristic may be determined. In an embodiment, a multi-time programming (MTP) operation may be performed in the manufacturing process of the display device 1 to repeatedly correct the display device 1 in terms of luminance and/or color coordinates. Through the MTP operation, a plurality of the power voltage offset lookup tables ELUT may be generated. However, embodiments of the present disclosure are not limited to a method for generating the plurality of the power voltage offset lookup tables ELUT. For example, a first power voltage offset lookup table corresponding to a first luminance setting may be stored. For example, a second power voltage offset lookup table corresponding to a third luminance setting may be stored.

The gamma reference voltage offset determiner 220-2 may output gamma reference voltage offset data GROD based on the gamma reference voltage changed data GRD. The gamma reference voltage offset data ELOD may be generated based on a gamma reference voltage offset lookup table GRLUT corresponding to a change in the gamma reference voltage VGREF. The gamma reference voltage offset lookup table GRLUT may be stored in the manufacturing process of the display device 1. The gamma reference voltage offset lookup table GRLUT may include offset voltages considering a panel characteristic (e.g., a size of the display panel, a material of the display panel, etc.). For example, the data voltage VDATA such that the pixel PX emits at a luminance setting may be changed based on the panel characteristic. The gamma reference voltage offset voltage may be considered to the data voltage VDATA, such that the pixel PX may emit at the luminance setting.

The gamma reference voltage offset lookup table GRLUT may include the offset voltages corresponding to grayscales in which the pixel PX can emit. For example, the gamma reference voltage offset lookup table GRLUT may include a first gamma reference voltage offset voltage corresponding to a first grayscale, a second gamma reference voltage offset voltage corresponding to a second grayscale to a P-th gamma reference voltage offset voltage corresponding to a P-th grayscale. For example, in the manufacturing process of the display device 1, by using a determining apparatus, the gamma reference voltage offset voltage in which the panel characteristic may be determined. In an embodiment, a multi-time programming (MTP) operation may be performed in the manufacturing process of the display device 1 to repeatedly correct the display device 1 in terms of luminance and/or color coordinates. Through the MTP operation, a plurality of the gamma reference voltage offset lookup tables GRLUT may be generated. However, embodiments of the present disclosure are not limited to a method for generating the plurality of the gamma reference voltage offset lookup tables GRLUT. For example, a gamma reference power voltage offset lookup table corresponding to a first luminance setting may be stored. For example, a second gamma reference voltage offset lookup table corresponding to a third luminance setting may be stored. In an embodiment, the number of the gamma reference voltage offset lookup tables GRLUT may greater than the number of the power voltage offset lookup tables ELUT.

The data signal compensator 230 may receive the input image data IMG, the power voltage offset data ELOD and the gamma reference voltage offset data GROD. The data signal compensator 230 may include a grayscale lookup table GLUT. The grayscale lookup table GLUT may store grayscale data voltages corresponding to a grayscale. For example, a first grayscale data voltage corresponding to a first grayscale may be stored For example, a second grayscale data voltage corresponding to a second grayscale may be stored. In an embodiment, the MTP operation may be performed in the manufacturing process of the display device 1 to repeatedly correct the display device 1 in terms of luminance and/or color coordinates. Through the MTP operation, grayscale lookup table GLUT may be generated. The data signal DATA in which the grayscale data voltage corresponding to the input image data IMG and the power voltage offset voltage and the gamma reference voltage offset voltage may be generated. The data signal compensator 230 may generate the data signal DATA based on the grayscale data voltage, the power voltage offset voltage and the gamma reference voltage offset voltage. In an embodiment, the data signal DATA may be a signal based on a value of a sum of the grayscale data voltage, the power voltage offset voltage and the gamma reference voltage offset voltage.

For example, a first data voltage for emitting the pixel PX as a first grayscale may be outputted. According to the panel characteristic, when the first data voltage is applied to the pixel PX, the pixel PX may emit light according to a second grayscale different from the first grayscale. In an example in which the first data voltage is applied to the pixel PX, the pixel PX may emit light according to the second grayscale different from the first grayscale according to a change in the power voltage ELV. In an example in which the first data voltage is applied to the pixel PX, the pixel PX may emit light according to the second grayscale different from the first grayscale according to a change in the gamma top voltage VTOP of FIG. 5. In an example in which the first data voltage is applied to the pixel PX, the pixel PX may emit light according to the second grayscale different from the first grayscale according to a change in the gamma bottom voltage VBOT of FIG. 5. Accordingly, a display quality may be deteriorated.

In an example in which a grayscale data voltage corresponding to the input image data IMG applied to the pixel PX is a grayscale level of about 10, the pixel PX may emit light according to a grayscale level different from the grayscale level of about 10 based on the panel characteristic. In an example in which a grayscale data voltage corresponding to the input image data IMG applied to the pixel PX is a grayscale level of about 10, the pixel PX may emit light according to a grayscale level different from the grayscale level of about 10 based on the change in the power voltage ELV. In an example in which a grayscale data voltage corresponding to the input image data IMG applied to the pixel PX is a grayscale level of about 10, the pixel PX may emit light according to a grayscale level different from the grayscale level of about 10 based on the change in the gamma top voltage VTOP of FIG. 5. In an example in which a grayscale data voltage corresponding to the input image data IMG applied to the pixel PX is a grayscale level of about 10, the pixel PX may emit light according to a grayscale level different from the grayscale level of about 10 based on the change in the gamma bottom voltage VBOT of FIG. 5.

In an example in which a grayscale data voltage corresponding to the input image data IMG is a data voltage corresponding to a grayscale level of about 10, and a data voltage considering the grayscale data voltage corresponding to the input image data IMG, the power voltage offset voltage and the gamma reference voltage offset voltage corresponds to a grayscale level of about 20, the data signal compensator 230 may output the data signal DATA such that the pixel PX emits light according to a grayscale level of about 20. In an example in which the pixel PX receives a data voltage corresponding to the data signal DATA such that the pixel PX emits light according to a grayscale level of about 20, the pixel PX may emit light according to a grayscale level of about 10 corresponding to the input image data IMG. So, the data signal DATA corresponding to the input image data IMG considering the panel characteristic may be generated. Accordingly, a display quality of the display panel 100 may be further improved.

FIG. 3 is a block diagram illustrating an example of a voltage generator 700 included in a display device 1 of FIG. 1. FIG. 4 is a graph illustrating an example of a low power voltage ELVSS outputted from a power voltage outputter 720 included in a voltage generator 700 of FIG. 3.

Referring to FIG. 1 to FIG. 4, the voltage generator 700 may include a power voltage receiver 710 and a power voltage outputter 720.

The power voltage receiver 710 may receive an input voltage VIN from an external device (e.g., power management integrated circuit). The power voltage receiver 710 may output the power voltage ELV and the driving voltage DV based on the input voltage VIN. A voltage of the power voltage ELV and a voltage level of the driving voltage DV may be different.

The power voltage outputter 720 may receive the power voltage ELV, the driving voltage DV, and the power voltage generating control signal CPVS. The power voltage outputter 720 may output a high power voltage ELVDD, the low power voltage ELVSS, an initialization voltage VINT, and the light emitting element initialization voltage VAINT based on the power voltage ELV, the driving voltage DV, and the power voltage generating control signal CPVS. The power voltage outputter 720 may control voltage levels of the high power voltage ELVDD, the low power voltage ELVSS, the initialization voltage VINT, and the light emitting element initialization voltage VAINT based on the power voltage generating control signal CPVS. For example, the power voltage outputter 720 may change the voltage levels of the high power voltage ELVDD, the low power voltage ELVSS, the initialization voltage VINT, and the light emitting element initialization voltage VAINT based on the power voltage generating control signal CPVS.

In an embodiment, the power voltage outputter 720 may change the low power voltage ELVSS based on the power voltage generating control signal CPVS. In an example in which the luminance setting SL is increased, the power voltage outputter 720 may decrease the low power voltage ELVSS.

The low power voltage ELVSS may be changed based on the luminance setting SL, such that a power consumption of the display device 1 may be reduced. In some aspects, the low power voltage ELVSS may be changed based on the luminance setting SL, such that a display quality in a high luminance of the display panel 100 may be improved.

FIG. 5 is a block diagram illustrating an example of a gamma reference voltage generator 400 included in a display device 1 of FIG. 1. FIG. 6 is a graph illustrating an example of a gamma bottom voltage VBOT outputted from a gamma reference voltage outputter 420 included in a gamma reference voltage generator 400 of FIG. 5.

Referring to FIG. 1, FIG. 2, FIG. 5 and FIG. 6, the gamma reference voltage generator 400 may include a gamma reference voltage controller 410 and a gamma reference voltage outputter 420.

The gamma reference voltage controller 410 may receive a first reference voltage VREF1 and a second reference voltage VREF2 from an external device (e.g., power management integrated circuit). In an embodiment, the gamma reference voltage controller 410 may receive the first reference voltage VREF1 and the second reference voltage VREF2 from the voltage generator 700. The gamma reference voltage controller 410 may receive the first gamma reference voltage VREF1, the second gamma reference voltage VREF2, and the gamma reference voltage generating control signal VGRS. The gamma reference voltage controller 410 may output the gamma top voltage VTOP and the gamma bottom voltage VBOT based on the first reference voltage VREF1, the second reference voltage VREF2 and the gamma reference voltage generating control signal VGRS. The gamma reference voltage controller 410 may control voltage levels of the gamma top voltage VTOP and the gamma bottom voltage VBOT based on the gamma reference voltage generating control signal VGRS. The gamma reference voltage controller 410 may change the voltage levels of the gamma top voltage VTOP and the gamma bottom voltage VBOT based on the gamma reference voltage generating control signal VGRS.

In an embodiment, the gamma reference voltage controller 410 may change the gamma bottom voltage VBOT based on the gamma reference voltage generating control signal VGRS. When the luminance setting is increased, the gamma reference voltage controller 410 may decrease the gamma reference voltage generating control signal VGRS.

The gamma bottom voltage VBOT may be changed based on the luminance setting SL, such that a power consumption of the display device 1 may be reduced. In some aspects, the gamma bottom voltage VBOT may be changed based on the luminance setting SL, such that a display quality in a high luminance of the display panel 100 may be improved.

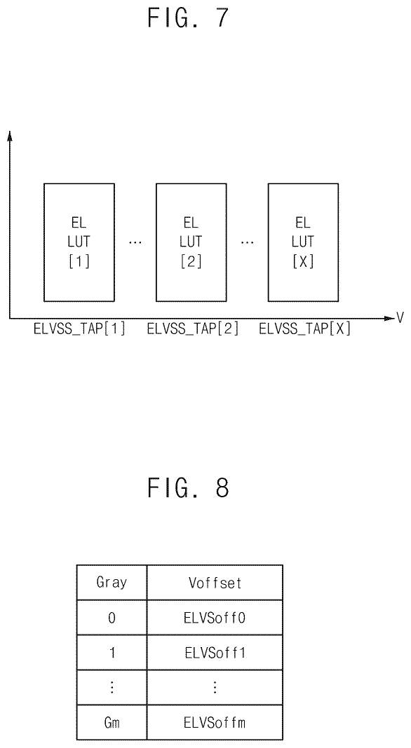

FIG. 7 is diagram illustrating an example of a plurality of power voltage offset lookup tables ELUT stored in a driving controller 200 of FIG. 2. FIG. 8 is a table illustrating an example of a power voltage offset lookup table ELUT of FIG. 7.

Referring to FIG. 1 to FIG. 8, the driving controller 200 may store a plurality of power voltage offset lookup tables ELUT. The power voltage offset determiner 220-1 may store the plurality of power voltage offset lookup tables ELUT. In the present embodiment, the power voltage offset lookup tables ELUT may be low power voltage offset lookup tables ELOLUT[1], ELOLUT[2] to ELOLUT[X]. The power voltage offset determiner 220-1 may output low power voltage offset data based on the low power voltage offset lookup tables ELOLUT[1], ELOLUT[2] to ELOLUT[X]. The low power voltage offset lookup tables ELOLUT[1], ELOLUT[2] to ELOLUT[X] may include first to X-th low power voltage offset lookup tables ELOLUT[1], ELOLUT[2] to ELOLUT[X]. the low power voltage offset lookup tables ELOLUT[1], ELOLUT[2] to ELOLUT[X] may be generated based on low power tap voltages ELVSS_TAP[1], ELVSS_TAP[2] and ELVSS_TAP[X].

For example, the low power offset voltages ELVSoff0, ELVSoff1 to ELVSoffm corresponding to a change in low power voltage ELVSS considering the panel characteristic may be determined in the manufacturing process of the display device 1. The low power offset voltages ELVSoff0, ELVSoff1 to ELVSoffm may have value corresponding to each of grayscales. For example, the low power offset voltages ELVSoff0, ELVSoff1 to ELVSoffm corresponding to about 0 grayscale level to a maximum grayscale level may be determined.

For example, the low power voltage ELVSS in a first luminance setting may be a first low power voltage. The first low power voltage may be called as a first low power tap voltage ELVSS_TAP[1]. In the manufacturing process of the display device 1, offset voltages in the first low power voltage considering and the panel characteristic may be determined. For example, through a determining apparatus in the manufacturing process of the display device 1, the offset voltages in the first low power voltage considering and the panel characteristic may be determined. Accordingly, first low power offset voltages corresponding to the first low power voltage may be determined. Accordingly, the first low power voltage offset lookup table ELOLUT[1] corresponding to the first low power voltage may be generated.

For example, the low power voltage ELVSS in a third luminance setting may be a second low power voltage different from the first low power voltage. The second low power voltage may be called as a second low power tap voltage ELVSS_TAP[2]. In the manufacturing process of the display device 1, offset voltages in the second low power voltage considering and the panel characteristic may be determined. For example, through a determining apparatus in the manufacturing process of the display device 1, the offset voltages in the second low power voltage considering and the panel characteristic may be determined. Accordingly, second low power offset voltages corresponding to the second low power voltage may be determined. Accordingly, the second low power voltage offset lookup table ELOLUT[2] corresponding to the second low power voltage may be generated.

For example, in a second luminance setting between the first luminance setting and the third luminance setting, the low power voltage ELVSS may be a first-first low power voltage between the first low power voltage and the second low power voltage. First-first low power offset voltages corresponding to the first-first low power voltage may be determined by performing a linear interpolation on the first low power offset voltages and the second low power offset voltages. In an example in which the first low power voltage is about −5V, the second low power voltage is about −4V, the first-first low power voltage is about −4.5V, a first low power offset voltage corresponding to a first grayscale of the first low power offset voltages is about 50 mV, and a second low power offset voltage corresponding to the first grayscale of the second low power offset voltages is about 30 mV, a first-first low power offset voltage corresponding to the first grayscale of the first-first low power offset voltages in which linear interpolation is performed may be about 40 mV.

The first-first low power voltage may be determined by performing linear interpolation on the first low power offset lookup table and the second low power offset lookup table. Accordingly, the low power voltage offset voltage may be determined without using a determining apparatus. Accordingly, the efficiency of the manufacturing process may be improved.

For example, the low power voltage ELVSS in a fourth luminance setting may be a third low power voltage different from the first low power voltage and the second low power voltage. The third low power voltage may be called as a third low power tap voltage. In the manufacturing process of the display device 1, offset voltages in the third low power voltage considering and the panel characteristic may be determined. For example, through a determining apparatus in the manufacturing process of the display device 1, the offset voltages in the third low power voltage considering and the panel characteristic may be determined. Accordingly, third low power offset voltages corresponding to the third low power voltage may be determined. Accordingly, the third low power voltage offset lookup table corresponding to the third low power voltage may be generated.

For example, the low power voltage ELVSS in a X-th luminance setting may be a X-th low power voltage different from the first low power voltage to the third low power voltage. The X-th low power voltage may be called as an X-th low power tap voltage ELVSS_TAP[X]. In the manufacturing process of the display device 1, offset voltages in the X-th low power voltage considering and the panel characteristic may be determined. For example, through a determining apparatus in the manufacturing process of the display device 1, the offset voltages in the X-th low power voltage considering and the panel characteristic may be determined. Accordingly, X-th low power offset voltages corresponding to the X-th low power voltage may be determined. Accordingly, the X-th low power voltage offset lookup table ELOLUT[X] corresponding to the X-th low power voltage may be generated.

In present embodiment, some of the plurality of low power voltage offset lookup tables ELOLUT[1], ELOLUT[2] to ELOLUT[X] may be generated by performing linear interpolation on the remainder of the plurality of low power voltage offset lookup tables ELOLUT[1], ELOLUT[2] to ELOLUT[X]. Accordingly, some of the offset lookup tables may be generated without using a determining apparatus. Accordingly, the efficiency of the manufacturing process may be improved.

In some aspects, in the present embodiment, the low power voltage ELVSS may be changed according to a change in the luminance setting. For generating a data signal DATA according to a change in the low power voltage ELVSS, the plurality of low power voltage offset lookup tables ELOLUT[1], ELOLUT[2] to ELOLUT[X] may be generated. The data signal DATA may be generated based on the low power offset lookup table corresponding to the changed low power voltage ELVSS. Accordingly, a data signal DATA considering panel characteristics may be generated. In some aspects, an influence due to a change in the low power voltage ELVSS according to the luminance setting may be considered. Accordingly, color distortion and/or brightness stability of the display panel 100 may be improved.

For example, the number of the low power tap voltages ELVSS_TAP[1], ELVSS_TAP[2] and ELVSS_TAP[X] may be set by user. In an example in which the number of the low power tap voltages ELVSS_TAP[1], ELVSS_TAP[2] and ELVSS_TAP[X] is increased, an accuracy of the low power offset lookup tables in which the linear interpolation is performed may be improved. In an example in which the number of the low power tap voltages ELVSS_TAP[1], ELVSS_TAP[2] and ELVSS_TAP[X] is decreased, the efficiency of the manufacturing process may be improved.

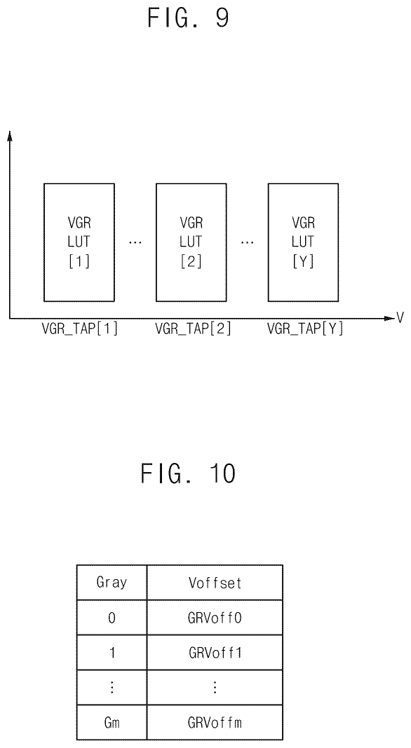

FIG. 9 is diagram illustrating an example of a plurality of gamma reference voltage offset lookup tables GRLUT stored in a driving controller 200 of FIG. 2. FIG. 10 is a table illustrating an example of a gamma reference voltage offset lookup table GRLUT of FIG. 7.

Referring to FIG. 1 to FIG. 10, the driving controller 200 may store a plurality of gamma reference voltage offset lookup tables GRLUT. The gamma reference voltage offset determiner 220-2 may store the plurality of gamma reference voltage offset lookup tables GRLUT. In the present embodiment, the gamma reference voltage offset lookup tables GRLUT may be gamma reference voltage offset lookup tables VGRLUT[1], VGRLOLUT[2] to VGROLUT[Y]. The gamma reference voltage offset determiner 220-2 may output a gamma reference voltage offset data based on the gamma reference voltage offset lookup tables VGRLUT[1], VGRLUT[2] to VGRLUT[Y]. The gamma reference voltage offset lookup tables VGRLUT[1], VGRLUT[2] to VGRLUT[Y] may include first to Y-th low power voltage offset lookup tables VGRLUT[1], VGRLUT[2] to VGRLUT[Y]. The gamma reference voltage offset lookup tables VGRLUT[1], VGRLUT[2] to VGRLUT[Y] may be generated based on gamma reference tap voltages VGR_TAP[1], VGR_TAP[2] and VGR_TAP[Y]. In an embodiment, the number of the gamma reference tap voltages VGR_TAP[1], VGR_TAP[2] and VGR_TAP[Y] may be greater than the number of the low power tap voltages ELVSS_TAP[1], ELVSS_TAP[2] and ELVSS_TAP[X] For example, the gamma reference voltage offset voltages GRVoff0, GRVoff1 to GRVoffm corresponding to a change in gamma reference voltage VGREF considering the panel characteristic may be determined in the manufacturing process of the display device 1. For example, the change in the gamma reference voltage VGREF may correspond to the change in the gamma bottom voltage VBOT. For example, the change in the gamma reference voltage VGREF may correspond to the change in the gamma top voltage VTOP. The gamma reference voltage offset voltages GRVoff0, GRVoff1 to GRVoffm may have value corresponding to each of grayscales. For example, the gamma reference voltage offset voltages GRVoff0, GRVoff1 to GRVoffm corresponding to about 0 grayscale level to a maximum grayscale level may be determined.

For example, the gamma bottom voltage VBOT in a first luminance setting may be a first gamma bottom voltage. The first gamma bottom voltage may be called as a first gamma bottom tap voltage VGR_TAP[1]. In the manufacturing process of the display device 1, offset voltages in the first gamma bottom voltage considering and the panel characteristic may be determined. For example, through a determining apparatus in the manufacturing process of the display device 1, the offset voltages in the first gamma bottom voltage considering and the panel characteristic may be determined. Accordingly, first gamma bottom voltage offset voltages corresponding to the first gamma bottom voltage may be determined. Accordingly, the first gamma bottom voltage offset lookup table VGRLUT[1] corresponding to the first gamma bottom voltage may be generated.

For example, the gamma bottom voltage VBOT in a third luminance setting may be a second gamma bottom voltage different from the first gamma bottom voltage. The second gamma bottom voltage may be called as a second gamma bottom tap voltage VGR_TAP[2]. In the manufacturing process of the display device 1, offset voltages in the second gamma bottom voltage considering and the panel characteristic may be determined. For example, through a determining apparatus in the manufacturing process of the display device 1, the offset voltages in the second gamma bottom voltage considering and the panel characteristic may be determined. Accordingly, second gamma bottom voltage offset voltages corresponding to the second gamma bottom voltage may be determined. Accordingly, the second gamma bottom voltage offset lookup table VGRLUT[2] corresponding to the second gamma bottom voltage may be generated.

For example, in a second luminance setting between the first luminance setting and the third luminance setting, the gamma bottom voltage VBOT may be a first-first gamma bottom voltage between the first gamma bottom voltage and the second gamma bottom voltage. First-first gamma bottom voltage offset voltages corresponding to the first-first gamma bottom voltage may be determined by performing a linear interpolation on the first gamma bottom voltage offset voltages and the second gamma bottom voltage offset voltages. In an example in which the first gamma bottom voltage is about 2V, the second gamma bottom voltage is about 1V, the first-first gamma bottom voltage is about 1.5V, a first gamma bottom voltage offset voltage corresponding to a twentieth grayscale of the first gamma bottom voltage offset voltages is about 20 mV, and a second gamma bottom voltage offset voltage corresponding to the twentieth grayscale of the second gamma bottom voltage offset voltages is about 15 mV, a first-first gamma bottom voltage offset voltage corresponding to the twentieth grayscale of the first-first gamma bottom voltage offset voltages in which linear interpolation is performed may be about 17.5 mV.

The first-first gamma bottom voltage may be determined by performing linear interpolation on the first gamma bottom voltage offset lookup table and the second gamma bottom voltage offset lookup table. Accordingly, the gamma bottom voltage offset voltage may be determined without using a determining apparatus. Accordingly, the efficiency of the manufacturing process may be improved.

For example, the gamma bottom voltage VBOT in a fourth luminance setting may be a third gamma bottom voltage different from the first gamma bottom voltage and the second gamma bottom voltage. The third gamma bottom voltage may be called as a third gamma bottom tap voltage. In the manufacturing process of the display device 1, offset voltages in the third gamma bottom voltage considering and the panel characteristic may be determined. For example, through a determining apparatus in the manufacturing process of the display device 1, the offset voltages in the third gamma bottom voltage considering and the panel characteristic may be determined. Accordingly, third gamma bottom voltage offset voltages corresponding to the third gamma bottom voltage may be determined. Accordingly, the third gamma bottom voltage offset lookup table corresponding to the third gamma bottom voltage may be generated.

For example, the gamma bottom voltage VBOT in a Y-th luminance setting may be a Y-th gamma bottom voltage different from the first gamma bottom voltage to the third gamma bottom voltage. The Y-th gamma bottom voltage may be called as a Y-th gamma bottom tap voltage VGR_TAP[Y]. In the manufacturing process of the display device 1, offset voltages in the Y-th gamma bottom voltage considering and the panel characteristic may be determined. For example, through a determining apparatus in the manufacturing process of the display device 1, the offset voltages in the Y-th gamma bottom voltage considering and the panel characteristic may be determined. Accordingly, Y-th gamma bottom voltage offset voltages corresponding to the Y-th gamma bottom voltage may be determined. Accordingly, the Y-th gamma bottom voltage offset lookup table VGRLUT[Y] corresponding to the Y-th gamma bottom voltage may be generated.

In present embodiment, some of the plurality of gamma bottom voltage offset lookup tables VGRLUT[1], VGRLUT[2] to VGRLUT[Y] may be generated by performing linear interpolation on the remainder of the plurality of gamma bottom voltage offset lookup tables VGRLUT[1], VGRLUT[2] to VGRLUT[Y]. Accordingly, some of the offset lookup tables may be generated without using a determining apparatus. Accordingly, the efficiency of the manufacturing process may be improved.

In some aspects, in the present embodiment, the gamma bottom voltage VBOT may be changed according to a change in the luminance setting. For generating a data signal DATA according to a change in the gamma bottom voltage VBOT, the plurality of gamma bottom voltage offset lookup tables VGRLUT[1], VGRLUT[2] to VGRLUT[Y] may be generated. The data signal DATA may be generated based on the gamma bottom voltage offset lookup table corresponding to the changed gamma bottom voltage VBOT. Accordingly, a data signal DATA considering panel characteristics may be generated. In some aspects, an influence due to a change in the gamma bottom voltage VBOT according to the luminance setting may be considered. Accordingly, color distortion and/or brightness stability of the display panel 100 may be improved.

For example, the number of the gamma bottom tap voltages VGR_TAP[1], VGR_TAP[2] and VGR_TAP[Y] may be set by user. In an example in which the number of the gamma bottom tap voltages VGR_TAP[1], VGR_TAP[2] and VGR_TAP[Y] is increased, an accuracy of the gamma bottom voltage offset lookup tables in which the linear interpolation is performed may be improved. In an example in which the number of the gamma bottom tap voltages VGR_TAP[1], VGR_TAP[2] and VGR_TAP[Y] is decreased, the efficiency of the manufacturing process may be improved.

In the present embodiment, the data signal compensator 230 may receive the input image data IMG, the power voltage offset data ELOD and the gamma reference voltage offset data GROD. In the present embodiment, the power voltage offset data ELOD may be data corresponding to the low power voltage offset voltage. In the present embodiment, the gamma reference voltage offset data GROD may be data corresponding to a gamma bottom voltage offset voltage. The data signal compensator 230 may include a grayscale lookup table GLUT. In the present embodiment, the data signal DATA in which the low power voltage offset voltage and the gamma bottom voltage offset voltage is considered to the grayscale data voltage corresponding to the input image data IMG may be generated. The data signal compensator 230 may generate the data signal DATA based on the grayscale data voltage, the low power voltage offset voltage, and the gamma bottom voltage offset voltage. In an embodiment, the data signal DATA may be based on a value which is a sum of the grayscale data voltage, the low power voltage offset voltage, and the gamma bottom voltage offset voltage.

In an example in which a grayscale data voltage corresponding to the input image data IMG is a data voltage corresponding to a grayscale level of about 10, and a data voltage considering the grayscale data voltage corresponding to the input image data IMG, the low power voltage offset voltage, and the gamma bottom voltage offset voltage corresponds to a grayscale level of about 20, the data signal compensator 230 may output the data signal DATA such that the pixel PX emits light according to a grayscale level of about 20. In an example in which the pixel PX receives a data voltage corresponding to the data signal DATA such that pixel PX emits light according to a grayscale level of about 20, the pixel PX may emit light according to a grayscale level of about 10 corresponding to the input image data IMG. So, the data signal DATA corresponding to the input image data IMG considering the panel characteristic may be generated. Accordingly, a display quality of the display panel 100 may be further improved.

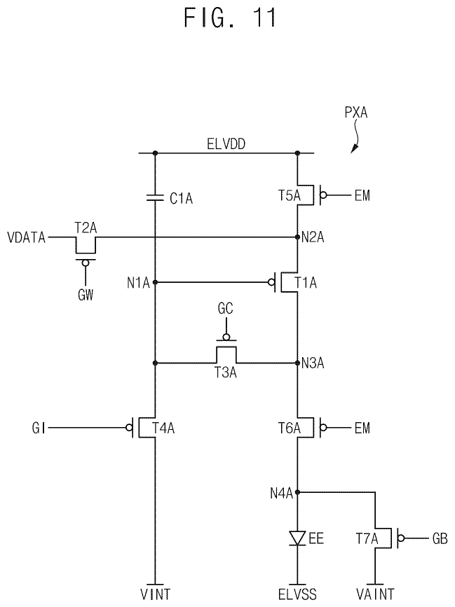

FIG. 11 is a circuit diagram illustrating an example of a pixel PX included a display device 1 of FIG. 1.

Referring to FIG. 1 and FIG. 11, a pixel PXA may include a first transistor T1A, a second transistor T2A, a third transistor T3A, a fourth transistor T4A, a fifth transistor T5A, a sixth transistor T6A, a seventh transistor T7A, a storage capacitor C1A and the light emitting element EE.

The first transistor T1A may include a control electrode connected to a first node N1A, a first electrode connected to a second node N2A and a second electrode connected to a third node N3A. The first transistor T1A may generate a driving current based on a voltage of the first node N1A. For example, the first transistor T1A may be called as the driving transistor. In the present embodiment, the first transistor T1A may be P-type transistor.

The second transistor T2A may include a control electrode receiving a write gate signal GW, a first electrode receiving the data voltage VDATA and a second electrode connected to the second node N2A. The second transistor T2A may apply the data voltage VDATA to the second node N2A in response to the write gate signal GW. For example, the second transistor T2A may be called as the write transistor.

The third transistor T3A may include a control electrode receiving the compensation gate signal GC, a first electrode connected to the third node N3A and a second electrode connected to the first node N1A. The third transistor T3A may connect the first node N1A and the third node N3A in response to the compensation gate signal GC. For example, the third transistor T3A may diode-connect the first transistor T1A in response to the compensation gate signal GC. For example, the third transistor T3A may be called as the compensation transistor.

The fourth transistor T4A may include a control electrode receiving the initialization gate signal GI, a first electrode receiving the initialization voltage VINT, and a second electrode connected to the first node N1A. The fourth transistor T4A may apply the initialization voltage VINT to the first node N1A in response to the initialization gate signal GI. For example, the fourth transistor T4A may be called as the initialization transistor.

The fifth transistor T5A may include a control electrode receiving the emission signal EM, a first electrode receiving the high power voltage ELVDD and a second electrode connected to the second node N2A. The fifth transistor T5A may apply the high power voltage ELVDD to the second node N2A in response to the emission signal EM. For example, the fifth transistor T5A may be called as a first emission transistor.

The sixth transistor T6A may include a control electrode receiving the emission signal EM, a first electrode connected to the third node N3A and a second electrode connected to a fourth node N4A. The sixth transistor T6A may connect the third node N3A and the fourth node N4A in response to the emission signal EM. For example, the sixth transistor T6A may be called as a second emission transistor.

The seventh transistor T7A may include a control electrode receiving the bias gate signal GB, a first electrode receiving the light emitting element initialization voltage VAINT and a second electrode connected to the fourth node N4A. The seventh transistor T7A may apply the initialization voltage VAINT to the fourth node N4A in response to the initialization gate signal GB.

The storage capacitor C1A may include a first electrode receiving the high power voltage ELVDD and a second electrode connected to the first node N1B. The storage capacitor C1A may store a voltage of the first node N1A. For example, the first capacitor C1A may be called as a storage capacitor.

The light emitting element EE may include a first electrode connected to the fourth node N4A and a second electrode receiving the low power voltage ELVSS. The light emitting element EE may emit light based on the driving current.

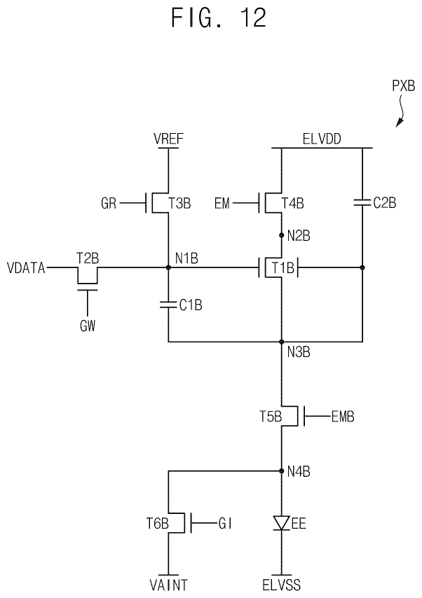

FIG. 12 is a circuit diagram illustrating an example of a pixel PX included a display device 1 of FIG. 1.

Referring to FIG. 1 and FIG. 12, a pixel PXB may include a first transistor T1B, a second transistor T2B, a third transistor T3B, a fourth transistor T4B, a fifth transistor T5B, a sixth transistor T6B, a first capacitor C1B and the light emitting element EE. In an embodiment, the pixel PXB may further include a second capacitor C2B.

The first transistor T1B may include a control electrode connected to a first node N1B, a first electrode connected to a second node N2B and a second electrode connected to a third node N3B. The first transistor T1B may generate the driving current based on a voltage of the first node N1B. In an embodiment, the first transistor T1B may further include a second control electrode connected to the third node N3B. For example, the first transistor T1B may be called as the driving transistor. In the present embodiment, the first transistor T1B may be an N-type transistor.

The second transistor T2B may include a control electrode receiving the write gate signal GW, a first electrode receiving the data voltage VDATA and a second electrode connected to the first node N1B. The second transistor T2B may apply the data voltage VDATA to the first node N1B in response to the write gate signal GW. For example, the second transistor T2B may be called as the write transistor.

The third transistor T3B may include a control electrode receiving a reset gate signal GR, a first electrode receiving a pixel reference voltage VREF and a second electrode connected to the first node N1B. The third transistor T3B may apply the pixel reference voltage VREF to the first node N1B in response to the reset gate signal GR. For example, the third transistor T3B may be called as the initialization transistor.

The fourth transistor T4B may include a control electrode receiving an emission signal EM, a first electrode receiving the first power voltage ELVDD and a second electrode connected to the second node N2B. The fourth transistor T4B may apply the first power voltage ELVDD to the second node N2B in response to the emission signal EM. For example, the fourth transistor T4B may be called as the first emission transistor.

The fifth transistor T5B may include a control electrode receiving a second emission signal EMB, a first electrode connected to the third node N3B and a second electrode connected to a fourth node N4B. The fifth transistor T5B may connect the third node N3B and the fourth node N4B in response to the second emission signal EMB. For example, the fifth transistor T5B may be called as the second emission transistor.

The sixth transistor T6B may include a control electrode receiving the lee initialization gate signal GI, a first electrode receiving the light emitting element initialization voltage VAINT and a second electrode connected to the fourth node N4B. The sixth transistor T6B may apply the light emitting element initialization voltage VAINT to the fourth node N4B in response to the initialization gate signal GI. For example, the sixth transistor T6C may be called as the light emitting element initialization transistor.

The first capacitor C1B may include a first electrode connected to the first node N1B and a second electrode connected to the third node N3B. The second capacitor C2B may include a first electrode receiving the first power voltage ELVDD and a second electrode connected to the third node N3B.

The light emitting element EE may include a first electrode connected to the fourth node N4B and a second electrode receiving the second power voltage ELVSS. The light emitting element EE may emit light based on the driving current.

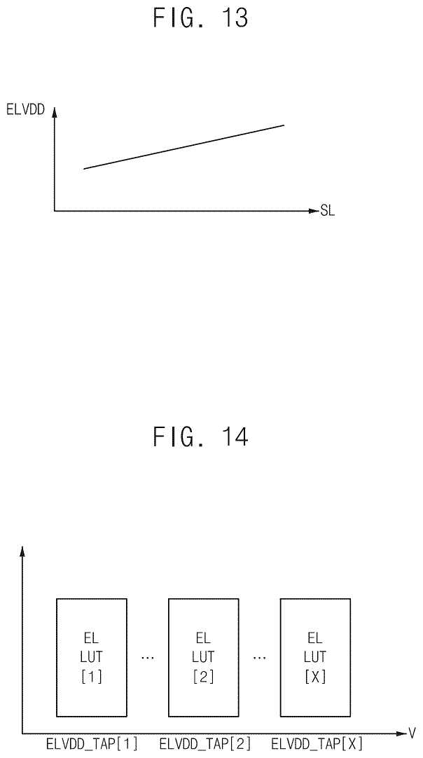

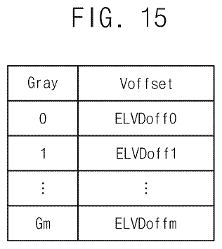

FIG. 13 is a graph illustrating an example of a high power voltage ELVDD outputted from a power voltage outputter 720 included in a voltage generator 700 of FIG. 3, and applied to a pixel PXB of FIG. 12. FIG. 14 is diagram illustrating an example of a plurality of power voltage offset lookup tables ELUT stored in a driving controller 200 of FIG. 2. FIG. 15 is a table illustrating an example of a power voltage offset lookup table ELUT of FIG. 14.

Referring to FIG. 1 to FIG. 3, FIG. 5, FIG. 9, FIG. 10 and FIG. 13 to FIG. 15, in an embodiment, the power voltage outputter 720 may change the high power voltage ELVDD based on the power voltage generating control signal CPVS. In an example in which the luminance setting SL is increased, the power voltage outputter 720 may increase the high power voltage ELVDD.

The high power voltage ELVDD may be changed based on the luminance setting SL, such that a power consumption of the display device 1 may be reduced. In some aspects, the high power voltage ELVDD may be changed based on the luminance setting SL, such that a display quality in a high luminance of the display panel 100 may be improved.

The driving controller 200 may store a plurality of power voltage offset lookup tables ELUT. The power voltage offset determiner 220-1 may store the plurality of power voltage offset lookup tables ELUT. In the present embodiment, the power voltage offset lookup tables ELUT may be high power voltage offset lookup tables ELOLUT[1], ELOLUT[2] to ELOLUT[X]. The power voltage offset determiner 220-1 may output high power voltage offset data based on the high power voltage offset lookup tables. The high power voltage offset lookup tables may include first to X-th high power voltage offset lookup tables. The high power voltage offset lookup tables may be generated based on high power tap voltages ELVDD_TAP[1], ELVDD_TAP[2] and ELVDD_TAP[X].

For example, the high power offset voltages ELVDoff0, ELVDoff1 to ELVDoffm corresponding to a change in high power voltage ELVDD considering the panel characteristic may be determined in the manufacturing process of the display device 1. The high power offset voltages ELVDoff0, ELVDoff1 to ELVDoffm may have value corresponding to each of grayscales. For example, the high power offset voltages ELVDoff0, ELVDoff1 to ELVDoffm corresponding to about 0 grayscale level to a maximum grayscale level may be determined.

For example, the high power voltage ELVDD in a first luminance setting may be a first high power voltage. The first high power voltage may be called as a first high power tap voltage ELVDD_TAP[1]. In the manufacturing process of the display device 1, offset voltages in the first high power voltage considering and the panel characteristic may be determined. For example, through a determining apparatus in the manufacturing process of the display device 1, the offset voltages in the first high power voltage considering and the panel characteristic may be determined. Accordingly, first high power offset voltages corresponding to the first high power voltage may be determined. Accordingly, the first high power voltage offset lookup table corresponding to the first high power voltage may be generated.

For example, the high power voltage ELVDD in a third luminance setting may be a second high power voltage different from the first high power voltage. The second high power voltage may be called as a second high power tap voltage ELVDD_TAP[2]. In the manufacturing process of the display device 1, offset voltages in the second high power voltage considering and the panel characteristic may be determined. For example, through a determining apparatus in the manufacturing process of the display device 1, the offset voltages in the second high power voltage considering and the panel characteristic may be determined. Accordingly, second high power offset voltages corresponding to the second high power voltage may be determined. Accordingly, the second high power voltage offset lookup table corresponding to the second high power voltage may be generated.

For example, in a second luminance setting between the first luminance setting and the third luminance setting, the high power voltage ELVDD may be a first-first high power voltage between the first high power voltage and the second high power voltage. First-first high power offset voltages corresponding to the first-first high power voltage may be determined by performing a linear interpolation on the first high power offset voltages and the second high power offset voltages. In an example in which the first high power voltage is about 10V, the second high power voltage is about 14V, the first-first high power voltage is about 12V, a first high power offset voltage corresponding to a hundredth grayscale of the first high power offset voltages is about 3 mV, and a second high power offset voltage corresponding to the hundredth grayscale of the second high power offset voltages is about 1 mV, a first-first high power offset voltage corresponding to the hundredth grayscale of the first-first high power offset voltages in which linear interpolation is performed may be about 2 mV.

The first-first high power voltage may be determined by performing linear interpolation on the first high power offset lookup table and the second high power offset lookup table. Accordingly, the high power voltage offset voltage may be determined without using a determining apparatus. Accordingly, the efficiency of the manufacturing process may be improved.

For example, the high power voltage ELVDD in a fourth luminance setting may be a third high power voltage different from the first high power voltage and the second high power voltage. The third high power voltage may be called as a third high power tap voltage. In the manufacturing process of the display device 1, offset voltages in the third high power voltage considering and the panel characteristic may be determined. For example, through a determining apparatus in the manufacturing process of the display device 1, the offset voltages in the third high power voltage considering and the panel characteristic may be determined. Accordingly, third high power offset voltages corresponding to the third high power voltage may be determined. Accordingly, the third high power voltage offset lookup table corresponding to the third high power voltage may be generated.

For example, the high power voltage ELVDD in a X-th luminance setting may be a X-th high power voltage different from the first high power voltage to the third high power voltage. The X-th high power voltage may be called as an X-th high power tap voltage ELVDD_TAP[X]. In the manufacturing process of the display device 1, offset voltages in the X-th high power voltage considering and the panel characteristic may be determined. For example, through a determining apparatus in the manufacturing process of the display device 1, the offset voltages in the X-th high power voltage considering and the panel characteristic may be determined. Accordingly, X-th high power offset voltages corresponding to the X-th high power voltage may be determined. Accordingly, the X-th high power voltage offset lookup table corresponding to the X-th high power voltage may be generated.

In present embodiment, some of the plurality of high power voltage offset lookup tables may be generated by performing linear interpolation on the remainder of the plurality of high power voltage offset lookup tables. Accordingly, some of the offset lookup tables may be generated without using a determining apparatus. Accordingly, the efficiency of the manufacturing process may be improved.

In some aspects, in the present embodiment, the high power voltage ELVDD may be changed according to a change in the luminance setting. For generating a data signal DATA according to a change in the high power voltage ELVDD, the plurality of high power voltage offset lookup tables may be generated. The data signal DATA may be generated based on the high power offset lookup table corresponding to the changed high power voltage ELVDD. Accordingly, a data signal DATA considering panel characteristics may be generated. In some aspects, an influence due to a change in the high power voltage ELVDD according to the luminance setting may be considered. Accordingly, color distortion and/or brightness stability of the display panel 100 may be improved.

For example, the number of the high power tap voltages ELVDD_TAP[1], ELVDD_TAP[2] and ELVDD_TAP[X] may be set by user. In an example in which the number of the high power tap voltages ELVDD_TAP[1], ELVDD_TAP[2] and ELVDD_TAP[X] is increased, an accuracy of the high power offset lookup tables in which the linear interpolation is performed may be improved. In an example in which the number of the high power tap voltages ELVDD_TAP[1], ELVDD_TAP[2] and ELVDD_TAP[X] is decreased, the efficiency of the manufacturing process may be improved.

In the present embodiment, the gamma top voltage VTOP may be changed based on the luminance setting SL.

For example, the gamma reference voltage offset voltages GRVoff0, GRVoff1 to GRVoffm corresponding to a change in gamma reference voltage VGREF considering the panel characteristic may be determined in the manufacturing process of the display device 1.

In the present embodiment, the change in the gamma reference voltage VGREF may correspond to the change in the gamma top voltage VTOP. The gamma reference voltage offset voltages GRVoff0, GRVoff1 to GRVoffm may have value corresponding to each of grayscales. For example, the gamma reference voltage offset voltages GRVoff0, GRVoff1 to GRVoffm corresponding to about 0 grayscale level to a maximum grayscale level may be determined.

For example, the gamma top voltage VTOP in a first luminance setting may be a first gamma top voltage. The first gamma top voltage may be called as a first gamma top tap voltage. In the manufacturing process of the display device 1, offset voltages in the first gamma top voltage considering and the panel characteristic may be determined. For example, through a determining apparatus in the manufacturing process of the display device 1, the offset voltages in the first gamma top voltage considering and the panel characteristic may be determined. Accordingly, first gamma top voltage offset voltages corresponding to the first gamma top voltage may be determined. Accordingly, the first gamma top voltage offset lookup table corresponding to the first gamma top voltage may be generated.

For example, the gamma top voltage VTOP in a third luminance setting may be a second gamma top voltage different from the first gamma top voltage. The second gamma top voltage may be called as a second gamma top tap voltage. In the manufacturing process of the display device 1, offset voltages in the second gamma top voltage considering and the panel characteristic may be determined. For example, through a determining apparatus in the manufacturing process of the display device 1, the offset voltages in the second gamma top voltage considering and the panel characteristic may be determined. Accordingly, second gamma top voltage offset voltages corresponding to the second gamma top voltage may be determined. Accordingly, the second gamma top voltage offset lookup table corresponding to the second gamma top voltage may be generated.

For example, in a second luminance setting between the first luminance setting and the third luminance setting, the gamma top voltage VTOP may be a first-first gamma top voltage between the first gamma top voltage and the second gamma top voltage. First-first gamma top voltage offset voltages corresponding to the first-first gamma top voltage may be determined by performing a linear interpolation on the first gamma top voltage offset voltages and the second gamma top voltage offset voltages. In an example in which the first gamma top voltage is about 7V, the second gamma top voltage is about 10V, the first-first gamma top voltage is about 8.5V, a first gamma bottom voltage offset voltage corresponding to a 200-th grayscale of the first gamma top voltage offset voltages is about 2 mV, and a second gamma top voltage offset voltage corresponding to the 200-th grayscale of the second gamma top voltage offset voltages is about 4 mV, a first-first gamma top voltage offset voltage corresponding to the 200-th grayscale of the first-first gamma top voltage offset voltages in which linear interpolation is performed may be about 3 mV.

The first-first gamma top voltage may be determined by performing linear interpolation on the first gamma top voltage offset lookup table and the second gamma top voltage offset lookup table. Accordingly, the gamma top voltage offset voltage may be determined without using a determining apparatus. Accordingly, the efficiency of the manufacturing process may be improved.

For example, the gamma top voltage VTOP in a fourth luminance setting may be a third gamma top voltage different from the first gamma top voltage and the second gamma top voltage. The third gamma top voltage may be called as a third gamma top tap voltage. In the manufacturing process of the display device 1, offset voltages in the third gamma top voltage considering and the panel characteristic may be determined. For example, through a determining apparatus in the manufacturing process of the display device 1, the offset voltages in the third gamma top voltage considering and the panel characteristic may be determined. Accordingly, third gamma top voltage offset voltages corresponding to the third gamma top voltage may be determined. Accordingly, the third gamma top voltage offset lookup table corresponding to the third gamma top voltage may be generated.

For example, the gamma top voltage VTOP in a Y-th luminance setting may be a Y-th gamma top voltage different from the first gamma top voltage to the third gamma top voltage. The Y-th gamma top voltage may be called as a Y-th gamma top tap voltage. In the manufacturing process of the display device 1, offset voltages in the Y-th gamma top voltage considering and the panel characteristic may be determined. For example, through a determining apparatus in the manufacturing process of the display device 1, the offset voltages in the Y-th gamma top voltage considering and the panel characteristic may be determined. Accordingly, Y-th gamma top voltage offset voltages corresponding to the Y-th gamma top voltage may be determined. Accordingly, the Y-th gamma top voltage offset lookup table corresponding to the Y-th gamma top voltage may be generated.

In present embodiment, some of the plurality of gamma top voltage offset lookup tables may be generated by performing linear interpolation on the remainder of the plurality of gamma top voltage offset lookup tables. Accordingly, some of the offset lookup tables may be generated without using a determining apparatus. Accordingly, the efficiency of the manufacturing process may be improved.

In some aspects, in the present embodiment, the gamma top voltage VTOP may be changed according to a change in the luminance setting. For generating a data signal DATA according to a change in the gamma top voltage VTOP, the plurality of gamma top voltage offset lookup tables may be generated. The data signal DATA may be generated based on the gamma top voltage offset lookup table corresponding to the changed gamma top voltage VTOP. Accordingly, a data signal DATA considering panel characteristics may be generated. In some aspects, an influence due to a change in the gamma top voltage VTOP according to the luminance setting may be considered. Accordingly, color distortion and/or brightness stability of the display panel 100 may be improved.

For example, the number of the gamma top tap voltages may be set by user. In an example in which the number of the gamma top tap voltages is increased, an accuracy of the gamma top voltage offset lookup tables in which the linear interpolation is performed may be improved. In an example in which the number of the gamma top tap voltages is decreased, the efficiency of the manufacturing process may be improved.

In the present embodiment, the data signal compensator 230 may receive the input image data IMG, the power voltage offset data ELOD and the gamma reference voltage offset data GROD. In the present embodiment, the power voltage offset data ELOD may be data corresponding to the high power voltage offset voltage. In the present embodiment, the gamma reference voltage offset data GROD may be data corresponding to a gamma top voltage offset voltage. The data signal compensator 230 may include a grayscale lookup table GLUT. In the present embodiment, the data signal DATA in which the high power voltage offset voltage and the gamma top voltage offset voltage is considered to the grayscale data voltage corresponding to the input image data IMG may be generated. The data signal compensator 230 may generate the data signal DATA based on the grayscale data voltage, the high power voltage offset voltage and the gamma top voltage offset voltage. In an embodiment, the data signal DATA may be based on a value which is a sum of the grayscale data voltage, the high power voltage offset voltage and the gamma top voltage offset voltage.

In an example in which a grayscale data voltage corresponding to the input image data IMG is a data voltage corresponding to about 50 grayscale level, and a data voltage considering the grayscale data voltage corresponding to the input image data IMG, the high power voltage offset voltage and the gamma top voltage offset voltage corresponds to about 52 grayscale level, the data signal compensator 230 may output the data signal DATA such that the pixel PX emits as about 52 grayscale level. In an example in which the pixel PX receives a data voltage corresponding to the data signal DATA such that pixel PX emits as about 52 grayscale level, the pixel PX may emit as about 50 grayscale level corresponding to the input image data IMG. So, the data signal DATA corresponding to the input image data IMG considering the panel characteristic may be generated. Accordingly, a display quality of the display panel 100 may be further improved.

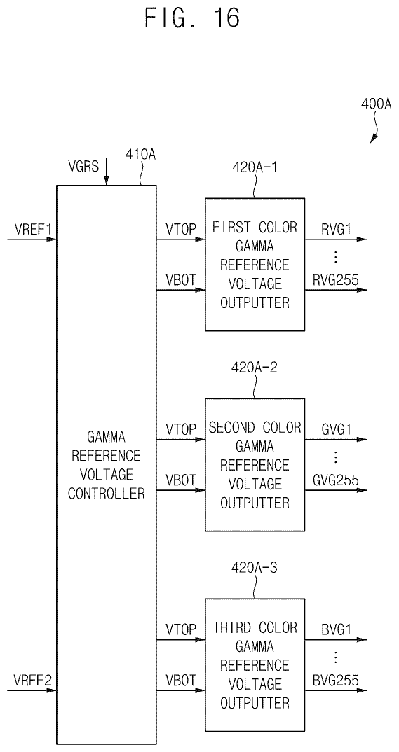

FIG. 16 is a block diagram illustrating an example of a gamma reference voltage generator 400 included in a display device 1 of FIG. 1.

Referring to FIG. 1 to FIG. 16, a gamma reference voltage generator 400A may include a gamma reference voltage controller 410A, a first color gamma reference voltage outputter 420A-1, a second color gamma reference voltage outputter 420A-2 and a third color gamma reference voltage outputter 420A-3.

The gamma reference voltage controller 410A may receive a first reference voltage VREF1 and a second reference voltage VREF2 from an external device (e.g., power management integrated circuit). In an embodiment, the gamma reference voltage controller 410A may receive the first reference voltage VREF1 and the second reference voltage VREF2 from the voltage generator 700. The gamma reference voltage controller 410A may receive the first gamma reference voltage VREF1, the second gamma reference voltage VREF2, and the gamma reference voltage generating control signal VGRS. The gamma reference voltage controller 410A may output the gamma top voltage VTOP and the gamma bottom voltage VBOT based on the first reference voltage VREF1, the second reference voltage VREF2 and the gamma reference voltage generating control signal VGRS. The gamma reference voltage controller 410A may control voltage levels of the gamma top voltage VTOP and the gamma bottom voltage VBOT based on the gamma reference voltage generating control signal VGRS. The gamma reference voltage controller 410A may change the voltage levels of the gamma top voltage VTOP and the gamma bottom voltage VBOT based on the gamma reference voltage generating control signal VGRS.

In an embodiment, the gamma reference voltage controller 410A may change the gamma bottom voltage VBOT based on the gamma reference voltage generating control signal VGRS. When the luminance setting is increased, the gamma reference voltage controller 410A may decrease the gamma bottom voltage VBOT generating control signal VGRS.

The gamma bottom voltage VBOT may be changed based on the luminance setting SL, such that a power consumption of the display device 1 may be reduced. In some aspects, the gamma bottom voltage VBOT may be changed based on the luminance setting SL, such that a display quality in a high luminance of the display panel 100 may be improved.

The first color gamma reference voltage outputter 420A-1 may receive the gamma top voltage VTOP and the gamma bottom voltage VBOT. For example, the first color may be red. The first color gamma reference voltage outputter 420A-1 may output first to 255-th red gamma reference voltages RVG1 to RVG255 based on the gamma top voltage VTOP and the gamma bottom voltage VBOT. The first red gamma reference voltage RVG1 may correspond to about 0 grayscale level. The 255-th red gamma reference voltage RVG255 may correspond to about 255 grayscale level. However, embodiments of the present disclosure are not limited to the number of the red gamma reference voltages outputted from the first color gamma reference voltage outputter 420A-1. For example, the first color gamma reference voltage outputter 420A-1 may output a red gamma reference voltage corresponding to about 2047-th grayscale level. The first red gamma reference voltage RVG1 may correspond to the gamma top voltage VTOP. The 255-th red gamma reference voltage RVG255 may correspond to the gamma bottom voltage VBOT.

The second color gamma reference voltage outputter 420A-2 may receive the gamma top voltage VTOP and the gamma bottom voltage VBOT. For example, the second color may be green. The second color gamma reference voltage outputter 420A-2 may output first to 255-th green gamma reference voltages GVG1 to GVG255 based on the gamma top voltage VTOP and the gamma bottom voltage VBOT. The first green gamma reference voltage GVG1 may correspond to about 0 grayscale level. The 255-th green gamma reference voltage GVG255 may correspond to about 255 grayscale level. However, embodiments of the present disclosure are not limited to the number of the green gamma reference voltages outputted from the second color gamma reference voltage outputter 420A-2. For example, the second color gamma reference voltage outputter 420A-2 may output a green gamma reference voltage corresponding to about 2047-th grayscale level. The first green gamma reference voltage GVG1 may correspond to the gamma top voltage VTOP. The 255-th green gamma reference voltage GVG255 may correspond to the gamma bottom voltage VBOT.

The third color gamma reference voltage outputter 420A-3 may receive the gamma top voltage VTOP and the gamma bottom voltage VBOT. For example, the third color may be blue. The third color gamma reference voltage outputter 420A-3 may output first to 255-th green gamma reference voltages BVG1 to BVG255 based on the gamma top voltage VTOP and the gamma bottom voltage VBOT. The first blue gamma reference voltage BVG1 may correspond to about 0 grayscale level. The 255-th blue gamma reference voltage BVG255 may correspond to about 255 grayscale level. However, embodiments of the present disclosure are not limited to the number of the blue gamma reference voltages outputted from the third color gamma reference voltage outputter 420A-3. For example, the third color gamma reference voltage outputter 420A-3 may output a blue gamma reference voltage corresponding to about 2047-th grayscale level. The first blue gamma reference voltage BVG1 may correspond to the gamma top voltage VTOP. The 255-th blue gamma reference voltage BVG255 may correspond to the gamma bottom voltage VBOT.

The first red gamma refence voltage RVG1, the first green gamma refence voltage GVG1 and the first blue gamma refence voltage BVG1 may be different. The 255-th red gamma refence voltage RVG255, the 255-th green gamma refence voltage GVG255 and the 255-th blue gamma refence voltage BVG255 may be different.

In an embodiment, a gamma top voltage and a gamma bottom voltage applied to the first color gamma reference voltage outputter 420A-1 may be inconsistent with a gamma top voltage and a gamma bottom voltage applied to the second color gamma reference voltage outputter 420A-2. In an embodiment, a gamma top voltage and a gamma bottom voltage applied to the first color gamma reference voltage outputter 420A-1 may be inconsistent with a gamma top voltage and a gamma bottom voltage applied to the third color gamma reference voltage outputter 420A-3. In an embodiment, a gamma top voltage and a gamma bottom voltage applied to the second color gamma reference voltage outputter 420A-2 may be inconsistent with a gamma top voltage and a gamma bottom voltage applied to the third color gamma reference voltage outputter 420A-3.

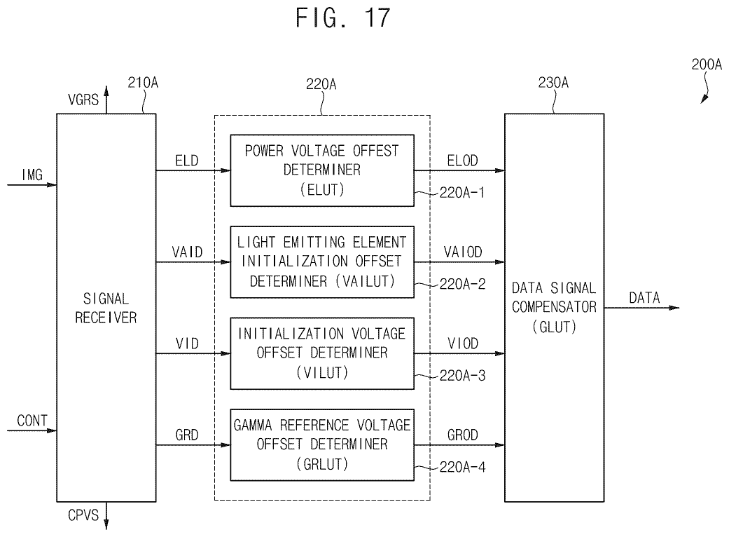

FIG. 17 is a block diagram illustrating an example of a driving controller 200 included in a display device 1 of FIG. 1.

Referring to FIG. 1, FIG. 5 and FIG. 17, the driving controller 200 may include the signal receiver 210, an offset determiner 220A and the data signal compensator 230. The offset determiner 220A may include a power voltage offset determiner 220A-1, a light emitting element initialization voltage offset determiner 220A-2, an initialization voltage offset determiner 220A-3 and a gamma reference voltage offset determiner 220A-4.

The signal receiver 210 may receive the input image data IMG and the input control signal CONT. The signal receiver 210 may output power a power voltage generating control signal CPVS and power voltage changed data ELD referring a change in the power voltage ELV based on the input control signal CONT. The signal receiver 210 may output power a gamma reference voltage generating control signal VGRS and gamma reference voltage changed data GRD referring a change in the gamma reference voltage VGREF based on the input control signal CONT. The signal receiver 210 may output light emitting element initialization changed data VAID referring a change in the light emitting element initialization voltage VAINT based on the input control signal CONT. The signal receiver 210 may output initialization changed data VID referring a change in the initialization voltage VINT based on the input control signal CONT.

The change in the power voltage ELVD may mean a difference of the power voltage ELV changed based on a change in the luminance setting. For example, the change in the power voltage ELVD may mean a voltage level difference between a first power voltage in a first luminance setting and a second power voltage in a second luminance setting. In an example in which a first low power voltage in the first luminance setting is about −4V, and a second low power voltage in the second luminance setting is about −5V, the change in the power voltage ELVD may be about 1V. The power voltage changed data ELD may mean data about a power voltage difference based on a change in the luminance setting.

The change in the gamma reference voltage VGREF may mean a difference of the gamma reference voltage VGREF changed based on a change in the luminance setting.

In an embodiment, the gamma bottom voltage VBOT may be changed based on the change in the luminance setting. In an example in which the gamma bottom voltage VBOT is changed based on the change in the luminance setting, the change in the gamma reference voltage VGREF may mean a voltage level difference between a first gamma bottom voltage in a first luminance setting and a second gamma bottom voltage in a second luminance setting. In an example in which the first gamma bottom voltage in the first luminance setting is about 3V, and the second gamma bottom voltage in the second luminance setting is about 2V, the change in the gamma reference voltage VGREF may be about 1V. The gamma reference voltage changed data GRD may mean data about a gamma reference voltage difference based on a change in the luminance setting.

In an embodiment, the gamma top voltage VTOP may be changed based on the change in the luminance setting. In an example in which the gamma top voltage VTOP is changed based on the change in the luminance setting, the change in the gamma reference voltage VGREF may mean a voltage level difference between a first top bottom voltage in a first luminance setting and a second gamma top voltage in a second luminance setting. In an example in which the first gamma top voltage in the first luminance setting is about 7V, and the second gamma top voltage in the second luminance setting is about 9V, the change in the gamma reference voltage VGREF may be about 2V. The gamma reference voltage changed data GRD may mean data about a gamma reference voltage difference based on a change in the luminance setting.

The change in the light emitting element initialization voltage VAINT may mean a difference of the light emitting element initialization voltage VAINT changed based on a change in the luminance setting. For example, the change in the light emitting element initialization voltage VAINT may mean that a voltage level difference between a first light emitting element initialization voltage in a first luminance setting and a second light emitting element initialization voltage in a second luminance setting. In an example in which a first light emitting element initialization voltage in the first luminance setting is about −6V, and a second light emitting element initialization voltage in the second luminance setting is about −6.5V, the change in the light emitting element initialization voltage VAINT may be about 0.5V. The light emitting element initialization voltage changed data VAID may mean data about a light emitting element initialization voltage difference based on a change in the luminance setting.

The change in the initialization voltage VINT may mean a difference of the initialization voltage VINT changed based on a change in the luminance setting. For example, the change in the initialization voltage VINT may mean that a voltage level difference between a first initialization voltage in a first luminance setting and a second initialization voltage in a second luminance setting. The initialization voltage changed data VID may mean data about an initialization voltage difference based on a change in the luminance setting.

The power voltage offset determiner 220A-1 may output power voltage offset data ELOD based on the power voltage changed data ELD. The power voltage offset data ELOD may be generated based on a power voltage offset lookup table ELUT corresponding to a change in the power voltage ELV. The power voltage offset lookup table ELUT may be stored in a manufacturing process of the display device 1. The power voltage offset lookup table ELUT may include offset voltages considering a panel characteristic (e.g., a size of the display panel, a material of the display panel, etc.). For example, the data voltage VDATA such that the pixel PX emits at a luminance setting may be changed based on the panel characteristic. The power voltage offset voltage may be considered to the data voltage VDATA, such that the pixel PX may emit at the luminance setting.

The power voltage offset lookup table ELUT may include the offset voltages corresponding to grayscales in which the pixel PX can emit. For example, the power voltage offset lookup table ELUT may include a first power voltage offset voltage corresponding to a first grayscale, a second power voltage offset voltage corresponding to a second grayscale to a P-th power voltage offset voltage corresponding to a P-th grayscale. Herein, P is a positive integer. For example, the P-th grayscale may be about 255 grayscale level. However, embodiments of the present disclosure are not limited to a value of a maximum grayscale in which the pixel emits. For example, in the manufacturing process of the display device 1, by using a determining apparatus, the power voltage offset voltage in which the panel characteristic may be determined. In an embodiment, a multi-time programming (MTP) operation may be performed in the manufacturing process of the display device 1 to repeatedly correct the display device 1 in terms of luminance and/or color coordinates. Through the MTP operation, a plurality of the power voltage offset lookup tables ELUT may be generated. However, embodiments of the present disclosure are not limited to a method for generating the plurality of the power voltage offset lookup tables ELUT. For example, a first power voltage offset lookup table corresponding to a first luminance setting may be stored. For example, a second power voltage offset lookup table corresponding to a third luminance setting may be stored.

The light emitting element initialization voltage offset determiner 220A-2 may output light emitting element initialization voltage offset data VAIOD based on the light emitting element initialization voltage changed data VAID. The light emitting element initialization voltage offset data VAIOD may be generated based on a light emitting element initialization voltage offset lookup table VAILUT corresponding to a change in the light emitting element initialization voltage VAINT. The light emitting element initialization voltage offset lookup table VAILUT may be stored in a manufacturing process of the display device 1. The light emitting element initialization voltage offset lookup table VAILUT may include offset voltages considering a panel characteristic (e.g., a size of the display panel, a material of the display panel, etc.). For example, the data voltage VDATA such that the pixel PX emits at a luminance setting may be changed based on the panel characteristic. The power voltage offset voltage may be considered to the data voltage VDATA, such that the pixel PX may emit at the luminance setting.

The light emitting element initialization voltage offset lookup table VAILUT may include the offset voltages corresponding to grayscales in which the pixel PX can emit. For example, the light emitting element initialization voltage offset lookup table VAILUT may include a first light emitting element initialization voltage offset voltage corresponding to a first grayscale, a second light emitting element initialization voltage offset voltage corresponding to a second grayscale to a P-th light emitting element initialization voltage offset voltage corresponding to a P-th grayscale. For example, in the manufacturing process of the display device 1, by using a determining apparatus, the light emitting element initialization voltage offset voltage in which the panel characteristic may be determined. In an embodiment, a multi-time programming (MTP) operation may be performed in the manufacturing process of the display device 1 to repeatedly correct the display device 1 in terms of luminance and/or color coordinates. Through the MTP operation, a plurality of the light emitting element initialization voltage offset lookup tables VAILUT may be generated. However, embodiments of the present disclosure are not limited to a method for generating the plurality of the light emitting element initialization voltage offset lookup tables VAILUT. For example, a first light emitting element initialization voltage offset lookup table corresponding to a first luminance setting may be stored. For example, a second light emitting element initialization voltage offset lookup table corresponding to a third luminance setting may be stored.

The initialization voltage offset determiner 220A-3 may output initialization voltage offset data VIOD based on the initialization voltage changed data VID. The initialization voltage offset data VIOD may be generated based on an initialization voltage offset lookup table VILUT corresponding to a change in the initialization voltage VINT. The initialization voltage offset lookup table VILUT may be stored in a manufacturing process of the display device 1. The initialization voltage offset lookup table VILUT may include offset voltages considering a panel characteristic (e.g., a size of the display panel, a material of the display panel, etc.). For example, the data voltage VDATA such that the pixel PX emits at a luminance setting may be changed based on the panel characteristic. The power voltage offset voltage may be considered to the data voltage VDATA, such that the pixel PX may emit at the luminance setting.

The initialization voltage offset lookup table VILUT may include the offset voltages corresponding to grayscales in which the pixel PX can emit. For example, the initialization voltage offset lookup table VILUT may include a first initialization voltage offset voltage corresponding to a first grayscale, a second initialization voltage offset voltage corresponding to a second grayscale to a P-th initialization voltage offset voltage corresponding to a P-th grayscale. For example, in the manufacturing process of the display device 1, by using a determining apparatus, the initialization voltage offset voltage in which the panel characteristic may be determined. In an embodiment, a multi-time programming (MTP) operation may be performed in the manufacturing process of the display device 1 to repeatedly correct the display device 1 in terms of luminance and/or color coordinates. Through the MTP operation, a plurality of the initialization voltage offset lookup tables VILUT may be generated. However, embodiments of the present disclosure are not limited to a method for generating the plurality of the initialization voltage offset lookup tables VILUT. For example, a first initialization voltage offset lookup table corresponding to a first luminance setting may be stored. For example, a second initialization voltage offset lookup table corresponding to a third luminance setting may be stored.

The gamma reference voltage offset determiner 220A-4 may output gamma reference voltage offset data GROD based on the gamma reference voltage changed data GRD. The gamma reference voltage offset data ELOD may be generated based on a gamma reference voltage offset lookup table GRLUT corresponding to a change in the gamma reference voltage VGREF. The gamma reference voltage offset lookup table GRLUT may be stored in the manufacturing process of the display device 1. The gamma reference voltage offset lookup table GRLUT may include offset voltages considering a panel characteristic (e.g., a size of the display panel, a material of the display panel, etc.). For example, the data voltage VDATA such that the pixel PX emits at a luminance setting may be changed based on the panel characteristic. The gamma reference voltage offset voltage may be considered to the data voltage VDATA, such that the pixel PX may emit at the luminance setting.

The gamma reference voltage offset lookup table GRLUT may include the offset voltages corresponding to grayscales in which the pixel PX can emit. For example, the gamma reference voltage offset lookup table GRLUT may include a first gamma reference voltage offset voltage corresponding to a first grayscale, a second gamma reference voltage offset voltage corresponding to a second grayscale to a P-th gamma reference voltage offset voltage corresponding to a P-th grayscale. For example, in the manufacturing process of the display device 1, by using a determining apparatus, the gamma reference voltage offset voltage in which the panel characteristic may be determined. In an embodiment, a multi-time programming (MTP) operation may be performed in the manufacturing process of the display device 1 to repeatedly correct the display device 1 in terms of luminance and/or color coordinates. Through the MTP operation, a plurality of the gamma reference voltage offset lookup tables GRLUT may be generated. However, embodiments of the present disclosure are not limited to a method for generating the plurality of the gamma reference voltage offset lookup tables GRLUT. For example, a gamma reference power voltage offset lookup table corresponding to a first luminance setting may be stored. For example, a second gamma reference voltage offset lookup table corresponding to a third luminance setting may be stored. In an embodiment, the number of the gamma reference voltage offset lookup tables GRLUT may greater than the number of the power voltage offset lookup tables ELUT.

The data signal compensator 230 may receive the input image data IMG, the power voltage offset data ELOD, the light emitting element initialization voltage offset data VAIOD, initialization voltage offset data VIOD and the gamma reference voltage offset data GROD. The data signal compensator 230 may include a grayscale lookup table GLUT. The grayscale lookup table GLUT may store grayscale data voltages corresponding to a grayscale. For example, a first grayscale data voltage corresponding to a first grayscale may be stored For example, a second grayscale data voltage corresponding to a second grayscale may be stored. In an embodiment, the MTP operation may be performed in the manufacturing process of the display device 1 to repeatedly correct the display device 1 in terms of luminance and/or color coordinates. Through the MTP operation, grayscale lookup table GLUT may be generated.

The data signal compensator 230 may generate the data signal DATA based on the grayscale data voltage, the power voltage offset voltage and the gamma reference voltage offset voltage. In an embodiment, the data signal compensator 230 may generate the data signal DATA based on the grayscale data voltage, the power voltage offset voltage, the light emitting element initialization offset voltage and the gamma reference voltage offset voltage. In an embodiment, the data signal compensator 230 may generate the data signal DATA based on the grayscale data voltage, the power voltage offset voltage, the initialization offset voltage and the gamma reference voltage offset voltage. In an embodiment, the data signal compensator 230 may generate the data signal DATA based on the grayscale data voltage, the power voltage offset voltage, the light emitting element initialization offset voltage, the initialization offset voltage and the gamma reference voltage offset voltage.

In an embodiment, the data signal DATA may be a signal based on a value of sum of the grayscale data voltage, the power voltage offset voltage and the gamma reference voltage offset voltage. In an embodiment, the data signal DATA may be a signal based on a value of sum of the grayscale data voltage, the power voltage offset voltage, the light emitting element initialization voltage offset voltage and the gamma reference voltage offset voltage. In an embodiment, the data signal DATA may be a signal based on a value of sum of the grayscale data voltage, the power voltage offset voltage, the initialization voltage offset voltage and the gamma reference voltage offset voltage. In an embodiment, In an embodiment, the data signal DATA may be a signal based on a value of sum of the grayscale data voltage, the power voltage offset voltage, the light emitting element initialization voltage offset voltage, the initialization voltage offset voltage and the gamma reference voltage offset voltage.

For example, a first data voltage for emitting the pixel PX as a first grayscale may be outputted. According to the panel characteristic, when the first data voltage is applied to the pixel PX, the pixel PX may emit as a second grayscale different from the first grayscale. In an example in which the first data voltage is applied to the pixel PX, the pixel PX may emit light according to the second grayscale different from the first grayscale according to a change in the power voltage ELV. In an example in which the first data voltage is applied to the pixel PX, the pixel PX may emit light according to the second grayscale different from the first grayscale according to a change in the gamma top voltage VTOP. In an example in which the first data voltage is applied to the pixel PX, the pixel PX may emit light according to the second grayscale different from the first grayscale according to a change in the gamma bottom voltage VBOT. Accordingly, a display quality may be deteriorated.

In an example in which a grayscale data voltage corresponding to the input image data IMG applied to the pixel PX is a grayscale level of about 10, the pixel PX may emit light according to a grayscale level different from the grayscale level of about 10 based on the panel characteristic. In an example in which a grayscale data voltage corresponding to the input image data IMG applied to the pixel PX is a grayscale level of about 10, the pixel PX may emit light according to a grayscale level different from the grayscale level of about 10 based on the change in the power voltage ELV. In an example in which a grayscale data voltage corresponding to the input image data IMG applied to the pixel PX is a grayscale level of about 10, the pixel PX may emit light according to a grayscale level different from the grayscale level of about 10 based on the change in the gamma top voltage VTOP. In an example in which a grayscale data voltage corresponding to the input image data IMG applied to the pixel PX is a grayscale level of about 10, the pixel PX may emit light according to a grayscale level different from the grayscale level of about 10 based on the change in the gamma bottom voltage VBOT.

In an example in which a grayscale data voltage corresponding to the input image data IMG is a data voltage corresponding to a grayscale level of about 10, and a data voltage considering the grayscale data voltage corresponding to the input image data IMG, the power voltage offset voltage and the gamma reference voltage offset voltage corresponds to a grayscale level of about 20, the data signal compensator 230 may output the data signal DATA such that the pixel PX emits light according to a grayscale level of about 20. In an example in which the pixel PX receives a data voltage corresponding to the data signal DATA such that pixel PX emits light according to a grayscale level of about 20, the pixel PX may emit light according to a grayscale level of about 10 corresponding to the input image data IMG. So, the data signal DATA corresponding to the input image data IMG considering the panel characteristic may be generated. Accordingly, a display quality of the display panel 100 may be further improved.

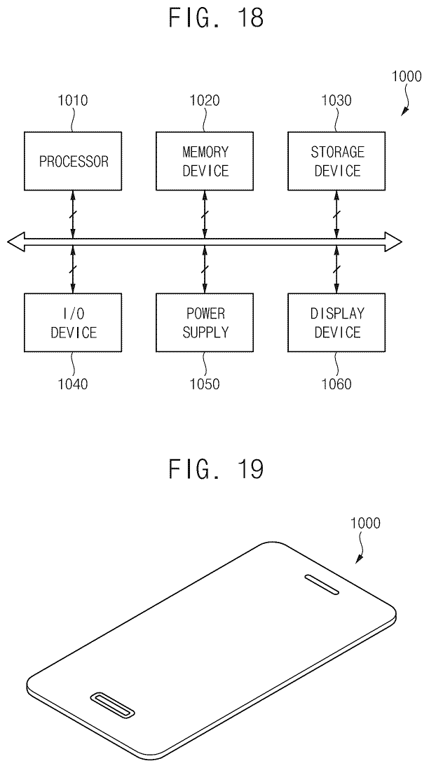

FIG. 18 is a block diagram illustrating an electronic device 1000 according to embodiments of the present disclosure. FIG. 19 is a diagram illustrating an example in which the electronic device of FIG. 18 is implemented as a smart phone.

Referring to FIG. 18, the electronic device 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In some aspects, the electronic device 1000 may further include a plurality of ports for communicating with a video card, a sound card, a memory card, a universal serial bus (USB) device, other electronic device, etc.

In an embodiment, as illustrated in FIG. 19, the electronic device 1000 may be implemented as a smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as, for example, a peripheral component interconnection (PCI) bus.

The processor 1010 may output the input image data IMG, the app-on signal APPON and the input control signal CONT to the driving controller 200 of FIG. 1.

The memory device 1020 may store data for operations of the electronic device 1000. For example, the memory device 1020 may include at least one non-volatile memory device such as, for example, an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as, for example, a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as, for example, a keyboard, a keypad, a mouse device, a touch-pad, a touch-screen, and the like and an output device such as, for example, a printer, a speaker, and the like. In some embodiments, the display apparatus 1060 may be included in the I/O device 1040. The power supply 1050 may provide power for operations of the electronic device 1000. The display apparatus 1060 may be coupled to other components via the buses or other communication links.

Referring to FIG. 19, the electronic device of the embodiments of the present disclosure is illustrated implemented as a smartphone, but embodiments of the present disclosure are not limited thereto. The electronic device may be a television, a monitor, a laptop computer, or a tablet. In some aspects, the electronic device may be a car.

The display device according to the embodiments may be applied to a display device included in a computer, a notebook, a mobile phone, a smart phone, a smart pad, a PMP, a PDA, an MP3 player, or the like.

The foregoing is illustrative of the embodiments of the present disclosure and is not to be construed as limiting thereof. Although example embodiments of the present disclosure have been described, those skilled in the art will readily appreciate that many modifications are possible in the embodiments without materially departing from the novel teachings and advantages of the embodiments of the present disclosure. Accordingly, all such modifications are intended to be included within the scope of the embodiments of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the embodiments of the present disclosure and is not to be construed as limited to the specific embodiments disclosed, and that modifications to the disclosed embodiments, as well as other embodiments, are intended to be included within the scope of the appended claims. Embodiments supported by the present disclosure are defined by the following claims, with equivalents of the claims to be included therein.

What is claimed is:

1. A display device comprising:
a display panel comprising a pixel;
a gate driver which outputs a gate signal to the pixel;
a data driver which applies a data voltage to the pixel based on a data signal and a gamma reference voltage;
a gamma reference voltage generator which applies the gamma reference voltage to the data voltage;
a voltage generator which outputs power voltages to the display panel; and
a driving controller which generates the data signal and controls the gate driver, the data driver, the voltage generator, and the gamma reference voltage generator,
wherein:
the pixel emits light according to a grayscale setting which is based on the power voltages and the data voltage,
the voltage generator changes at least one power voltage of the power voltages based on a luminance setting,
the gamma reference voltage generator changes the gamma reference voltage based on the luminance setting, and
the driving controller generates the data signal based on a change in the at least one power voltage and a change in the gamma reference voltage.

2. The display device of claim 1, wherein:
the power voltages comprise a high power voltage and a low power voltage lower than the high power voltage, and
when the luminance setting is changed to a second luminance setting higher than a first luminance setting, the voltage generator reduces the low power voltage.

3. The display device of claim 2, wherein:
the gamma reference voltage comprises a gamma high voltage and a gamma low voltage, and
when the luminance setting is changed to the second luminance setting, the gamma reference voltage generator reduces the gamma low voltage.

4. The display device of claim 3, wherein:
grayscale data voltages corresponding to a grayscale according to which the pixel emits light are stored in a grayscale voltage lookup table,
power voltage offset voltages corresponding to the change in the at least one power voltage are stored in a power voltage offset lookup table, and
the driving controller generates the data signal based on the grayscale voltage lookup table and the power voltage offset lookup table.

5. The display device of claim 4, wherein the data signal is outputted based on a grayscale data voltage of the grayscale data voltages and a power voltage offset voltage of the power voltage offset voltages.

6. The display device of claim 5, wherein the data signal is outputted based on a voltage which is a sum of the grayscale data voltage and the power voltage offset voltage.

7. The display device of claim 4, wherein gamma voltage offset voltages corresponding to the change in the gamma reference voltage are stored in a gamma voltage offset lookup table.

8. The display device of claim 7, wherein the data signal is outputted based on a grayscale data voltage of the grayscale data voltages, a power voltage offset voltage of the power voltage offset voltages, and a gamma voltage offset voltage of the gamma voltage offset voltages.

9. The display device of claim 8, wherein the data signal is outputted based on a voltage which is a sum of the grayscale data voltage, the power voltage offset voltage, and the gamma voltage offset voltage.

10. The display device of claim 7, wherein:
the gamma voltage offset lookup table comprises a first gamma voltage offset lookup table corresponding to the first luminance setting and a second gamma voltage offset lookup table corresponding to a third luminance setting higher than the first luminance setting, and
in the second luminance setting, a gamma voltage offset voltage of the gamma voltage offset voltages is determined by using linear interpolation on the first gamma voltage offset lookup table and the second gamma voltage offset lookup table.

11. The display device of claim 4, wherein:
the power voltage offset lookup table comprises a first power voltage offset lookup table corresponding to the first luminance setting and a second power voltage offset lookup table corresponding to a third luminance setting higher than the first luminance setting, and
in the second luminance setting, a power voltage offset voltage is determined by using linear interpolation on the first power voltage offset lookup table and the second power voltage offset lookup table.

12. The display device of claim 1, wherein:
the at least one power voltage comprises a high power voltage and a low power voltage lower than the high power voltage, and
when the luminance setting is changed to a second luminance setting higher than a first luminance setting, the voltage generator increases the high power voltage.

13. The display device of claim 12, wherein:
the gamma reference voltage comprises a gamma high voltage and a gamma low voltage, and
when the luminance setting is changed to the second luminance setting, the gamma reference voltage generator increases the gamma high voltage.

14. The display device of claim 13, wherein:
grayscale data voltages corresponding to a grayscale according to which the pixel emits light are stored in a grayscale voltage lookup table,
power voltage offset voltages corresponding to the change in the at least one power voltage are stored in a power voltage offset lookup table, and
the driving controller generates the data signal based on the grayscale voltage lookup table and the power voltage offset lookup table.

15. The display device of claim 14, wherein the data signal is outputted based on a grayscale data voltage of the grayscale data voltages and a power voltage offset voltage of the power voltage offset voltages.

16. The display device of claim 14, wherein:
gamma voltage offset voltages corresponding to the change in the gamma reference voltage are stored in a gamma voltage offset lookup table, and
the data signal is generated based on the grayscale voltage lookup table, the power voltage offset lookup table, and the gamma voltage offset lookup table.

17. The display device of claim 16, wherein the data signal is outputted based on a grayscale data voltage of the grayscale data voltages, a power voltage offset voltage of the power voltage offset voltages, and a gamma voltage offset voltage of the gamma voltage offset voltages.

18. An electronic device comprising:
a display panel comprising a pixel;
a gate driver which outputs a gate signal to the pixel;
a data driver which applies a data voltage to the pixel based on a data signal and a gamma reference voltage;
a gamma reference voltage generator which applies the gamma reference voltage to the data voltage;
a voltage generator which outputs power voltages to the display panel;
a driving controller which generates the data signal and controls the gate driver, the data driver, the voltage generator, and the gamma reference voltage generator; and
a processor which outputs input image data and an input control signal,
wherein:
the pixel emits light according to a grayscale setting which is based on the power voltages and the data voltage,
the voltage generator changes at least one power voltage of the power voltages based on a luminance setting,
the gamma reference voltage generator changes the gamma reference voltage based on the luminance setting, and
the driving controller generates the data signal based on a change in the at least one power voltage and a change in the gamma reference voltage.

19. The electronic device of claim 18, wherein:
the at least one power voltage comprises a high power voltage and a low power voltage lower than the high power voltage, and
when the luminance setting is changed to a second luminance setting higher than a first luminance setting, the voltage generator reduces the low power voltage.

20. The electronic device of claim 19, wherein:
the gamma reference voltage comprises a gamma high voltage and a gamma low voltage, and
when the luminance setting is changed to the second luminance setting, the gamma reference voltage generator reduces the gamma low voltage.
